(19) United States
(12) Patent Application Publication
(10) Pub. No.: US 2012/0052299 A1
(43) Pub. Date: Mar. 1, 2012

(54) NON-SPHERICAL ELECTROACTIVE AGGLOMERATED PARTICLES, AND ELECTRODES AND BATTERIES COMPRISING THE SAME

(76) Inventors: Jiang Fan, San Diego, CA (US); Dengguo Wu, San Diego, CA (US)

(21) Appl. No.: 13/221,980

(22) Filed: Aug. 31, 2011

Related U.S. Application Data
(60) Provisional application No. 61/378,945, filed on Sep. 1, 2010.

(51) Int. Cl. H01M 4/525; H01M 4/62; B32B 5/16; H01M 4/505; B32B 15/02; H01M 4/485; H01M 4/38

(52) U.S. Cl. 428/402; 252/182.1

(57) ABSTRACT

Provided herein is a non-spherical electroactive agglomerated particle, comprising one or more electroactive materials and optionally a binder. Also provided herein is a coated non-spherical electroactive particle, comprising i) a non-spherical agglomerated particle, which comprises one or more electroactive materials and optionally a binder, and ii) a polymeric overcoating on the surface of the non-spherical agglomerated particle.

### CROSS REFERENCE TO RELATED APPLICATIONS

This application claims the benefit of U.S. Provisional Application No. 61/378,945, filed Sep. 1, 2010; the disclosure of which is incorporated by reference herein in its entirety.

### FIELD

Provided herein is a non-spherical electroactive agglomerated particle, comprising one or more electroactive materials and optionally a binder. Also provided herein is a coated non-spherical electroactive particle, comprising i) a non-spherical agglomerated particle, which comprises one or more electroactive materials and optionally a binder, and ii) a polymeric overcoating on the surface of the non-spherical agglomerated particle.

### BACKGROUND

There is great interest in developing rechargeable lithium batteries with higher energy capacity and longer cycle life for applications in, e.g., portable electronic devices, electric vehicles, and implantable medical devices. Therefore, there is a need for a battery with high capacity and/or sufficient cycle performance.

### SUMMARY OF THE DISCLOSURE

Provided herein is a non-spherical electroactive agglomerated particle, comprising one or more electroactive materials and optionally a binder. In certain embodiments, the non-spherical electroactive agglomerated particle further comprises a diluent.

In one embodiment, the non-spherical electroactive agglomerated particle comprises one electroactive material. In another embodiment, the non-spherical electroactive agglomerated particle comprises two electroactive materials, a first and second electroactive material. In certain embodiments, the non-spherical electroactive agglomerated particle comprises subparticles of a first electroactive material and subparticles of a second electroactive material. In certain embodiments, the non-spherical electroactive agglomerated particle is an embedded particle comprising a first and second electroactive material. In one embodiment, the first electroactive material is embedded in the second electroactive material. In another embodiment, the second electroactive material is embedded in the first electroactive material.

Also provided herein is a coated non-spherical electroactive particle, comprising i) a non-spherical agglomerated particle, which comprises one or more electroactive materials and optionally a binder, and ii) a polymeric overcoating on the surface of the non-spherical agglomerated particle.

Further provided herein is an electrode that comprises i) a non-spherical electroactive particle comprising one or more electroactive materials and optionally a binder; or a coated non-spherical electroactive particle comprising (a) a non-spherical agglomerated particle, which comprises one or more electroactive materials and optionally a binder, and (b) a polymeric overcoating on the surface of the non-spherical agglomerated particle; ii) a current collector; and iii) optionally a binder.

Provided herein is a lithium battery, which comprises 1) an anode that comprises i) a non-spherical electroactive particle comprising one or more electroactive materials and optionally a binder; or a coated non-spherical electroactive particle comprising (a) a non-spherical agglomerated particle, which comprises one or more electroactive materials and optionally a binder, and (b) a polymeric overcoating on the surface of the non-spherical agglomerated particle; ii) a current collector; and iii) optionally a binder; 2) a cathode; and 3) an electrolyte that separates the anode and cathode.

Provided herein is a lithium battery, which comprises 1) a cathode that comprises i) a non-spherical electroactive particle comprising one or more electroactive materials and optionally a binder; or a coated non-spherical electroactive particle comprising (a) a non-spherical agglomerated particle, which comprises one or more electroactive materials and optionally a binder, and (b) a polymeric overcoating on the surface of the non-spherical agglomerated particle; ii) a current collector; and iii) optionally a binder; 2) an anode; and 3) an electrolyte that separates the anode and cathode.

Provided herein is a lithium battery, which comprises:

1) an anode that comprises i) a first non-spherical electroactive particle comprising one or more electroactive materials and optionally a binder; or a first coated non-spherical electroactive particle, comprising (a) a non-spherical agglomerated particle, which comprises one or more electroactive materials and optionally a binder, and (b) a polymeric overcoating on the surface of the non-spherical agglomerated particle; ii) a current collector; and iii) optionally a binder;

2) a cathode that comprises i) a second non-spherical electroactive particle comprising one or more electroactive materials and optionally a binder; or a second coated non-spherical electroactive particle, comprising (a) a non-spherical agglomerated particle, which comprises one or more electroactive materials and optionally a binder, and (b) a polymeric overcoating on the surface of the non-spherical agglomerated particle; ii) a current collector; and iii) optionally a binder; and

3) an electrolyte that separates the anode and cathode.

Provided herein is a method for preparing a non-spherical electroactive particle comprising one or more electroactive materials and optionally a binder, which comprises the steps of: i) shear mixing one or more electroactive materials and optionally a binder in a solvent to form a mixture; and ii) spray drying the mixture to form the non-spherical electroactive particle. In one embodiment, the method further comprises the step of curing the non-spherical electroactive particle at an elevated temperature.

Provided herein is a method for preparing a non-spherical electroactive particle comprising subparticles of one or more electroactive materials, and optionally a binder, which comprises the steps of: i) shear mixing subparticles of one or more electroactive materials, and optionally a binder, in a solvent to form a mixture; and ii) spray drying the mixture to form the non-spherical electroactive particle. In one embodiment, the method further comprises the step of curing the non-spherical electroactive particle at an elevated temperature.

### BRIEF DESCRIPTION OF THE FIGURES

FIGS. 1A, 1B, 1C, and 1D are SEM images of non-spherical electroactive particles that were prepared from LiFePO₄ and LiNiCoAlO₂, in combination of about 1% by weight of TORLON® AI-50.

FIGS. 2A, 2B, 2C, and 2D are SEM images of non-spherical electroactive particles that were prepared from LiFePO₄ and LiNiCoAlO₂, in combination of about 1% by weight of TORLON® AI-50 and 5% by weight of sucrose.

FIGS. 3A, 3B, 3C, and 3D are SEM images of non-spherical electroactive particles that were prepared from LiMn₂O₄ and LiNiCoAlO₂, in combination of about 1% by weight of TORLON® AI-50.

FIGS. 4A, 4B, 4C, and 4D are SEM images of non-spherical electroactive particles that were prepared from Si powders, in combination of about 8.4% by weight of TORLON® AI-50.

### DETAILED DESCRIPTION

To facilitate understanding of the disclosure set forth herein, a number of terms are defined below.

Generally, the nomenclature used herein and the laboratory procedures in electrochemistry, inorganic chemistry, polymer chemistry, organic chemistry, and others described herein are those well known and commonly employed in the art. Unless defined otherwise, all technical and scientific terms used herein generally have the same meaning as commonly understood by one of ordinary skill in the art to which this disclosure belongs.

The term “metal” refers to both metals and metalloids, including silicon and germanium. The phrase “a main group metal” is intended to include Sn, Si, Al, Bi, Ge, and Pb.

The term “anode” or “negative electrode” refers to an electrode where electrochemical oxidation occurs during discharging process. For example, an anode undergoes delithiation during discharging.

The term “cathode” or “positive electrode” refers to an electrode where electrochemical reduction occurs during discharging process. For example, a cathode undergoes lithiation during discharging.

The term “charging” refers to a process of providing electrical energy to an electrochemical cell.

The term “discharging” refers to a process of removing electrical energy from an electrochemical cell. In certain embodiments, discharging refers to a process of using the electrochemical cell to do useful work.

The term “electrochemically active,” “electrically active,” and “electroactive” are used interchangeably and refer to a material that is capable to incorporate lithium in its atomic lattice structure.

The term “lithiation” refers to a chemical process of inserting lithium into an electroactive material in an electrochemical cell. In certain embodiments, an electrode undergoes electrochemical reduction during lithiation process.

The term “delithiation” refers to a chemical process of removing lithium from an electroactive material in an electrochemical cell. In certain embodiments, an electrode undergoes electrochemical oxidation during delithiation process.

The term “about” or “approximately” means an acceptable error for a particular value as determined by one of ordinary skill in the art, which depends in part on how the value is measured or determined In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

The term “non-spherical” refers a particle having morphology of other than a sphere. Examples of non-spherical morphology include, but are not limited to, an ellipsoide, mushroom-head-shape, discoid (e.g., a disc-shape, double concave disc-shape, or flattened disc-shape), toroid (a doughnut shape), fibril, fiber, and platelet. In one embodiment, the particle is ellipsoidal. In another embodiment, the particle is discoidal. In yet another embodiment, the particle is toroidal. In yet another embodiment, the particle has at least one flattened surface. In still another embodiment, the particle has at least one concave surface.

### Non-Spherical Electroactive Agglomerated Particles

In one embodiment, provided herein is a non-spherical electroactive agglomerated particle comprising one or more electroactive materials and optionally a binder.

In certain embodiments, the non-spherical electroactive agglomerated particle comprises one electroactive material, and optionally a binder. In one embodiment, the non-spherical electroactive agglomerated particle comprises subparticles of one electroactive material, and optionally a binder. In another embodiment, the non-spherical electroactive agglomerated particle comprises a single type of subparticles of one electroactive material, and optionally a binder. In yet another embodiment, the non-spherical electroactive agglomerated particle comprises two or more types of subparticles of one electroactive material, and optionally a binder. In certain embodiments, the two or more types of subparticles of one electroactive material have different physical characteristics. In certain embodiments, the two or more types of subparticles of one electroactive material have different average particle sizes.

In certain embodiments, the non-spherical electroactive agglomerated particle comprises two or more electroactive materials, and optionally a binder. In certain embodiments, the non-spherical electroactive agglomerated particle comprises two electroactive materials, a first and second electroactive material, and optionally a binder. In one embodiment, the non-spherical electroactive agglomerated particle comprises subparticles of a first electroactive material and subparticles of a second electroactive material, and optionally a binder. In another embodiment, the first electroactive material is embedded in the second electroactive material. In yet another embodiment, the second electroactive material is embedded in the first electroactive material.

In yet another embodiment, the non-spherical electroactive agglomerated particle comprises a single type of subparticles of two electroactive materials, and optionally a binder. In certain embodiments, the single type of subparticles of two electroactive materials comprises embedded subparticles comprising a first electroactive material and one or more subparticles of a second electroactive material, and optionally a binder, wherein the one or more subparticles of the second electroactive material are embedded in the first electroactive material. In certain embodiments, the single type of subparticles of two electroactive materials comprises embedded subparticles comprising one or more subparticles of a first electroactive material, and a second electroactive material, and optionally a binder, wherein the one or more subparticles of the first electroactive material are embedded in the second electroactive material.

In yet another embodiment, the non-spherical electroactive agglomerated particle comprises two or more types of subparticles of two electroactive materials, and optionally a binder. In certain embodiments, the two or more types of subparticles of the two or more electroactive materials have different physical characteristics. In certain embodiments, the two or more types of subparticles of the two or more electroactive materials have different average particle sizes. In certain embodiments, the two or more types of subparticles of the two or more electroactive materials have different chemical compositions. In certain embodiments, the two or more types of subparticles of the two or more electroactive materials each contain a different electroactive material.

In certain embodiment, the non-spherical electroactive agglomerated particle provided herein further comprises at least one diluent or diluent subparticle. In certain embodiments, the non-spherical agglomerated particle provided herein comprises at least one electroactive subparticle, at least one diluent subparticle, and optionally a binder.

In certain embodiments, the amount of the at least one diluent or diluent subparticle in the non-spherical electroactive agglomerated particle provided herein is ranging from about 0.01 to about 50%, from about 0.01 to about 40%, from about 0.01 to about 30%, from about 0.01 to about 25%, from about 0.01 to about 20%, from about 0.05 to about 10%, from about 1 to about 10%, from about 0.1 to about 5%, from about 1 to about 5%, from about 1 to about 2%, from about 0.2 to about 2%, from about 1 to about 2%, from about 0.3 to about 1.5%, or from about 0.5 to about 1% by weight of the non-spherical electroactive agglomerated particle. In certain embodiments, the amount of the at least one diluent or diluent subparticle in the non-spherical electroactive agglomerated particle provided herein is about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.5%, about 3%, about 3.5%, about 4%, about 4.5%, about 5%, about 10%, about 15%, about 20%, or about 25% by weight of the non-spherical electroactive agglomerated particle.

Suitable diluent materials include, but are not limited to, acetylene black, ketjen black, furnace black, lamp black, carbon (including, but not limited to, disordered carbon, carbon black, graphite, carbon nanotubes, single-walled nanotubes, multi-wall nanotubes, and carbon fibers), aluminum, aluminum oxide, chromium, chromium boride, chromium carbide, copper, cobalt, gold, hafnium boride, hafnium carbide, hafnium nitride, iron, lead, molybdenum, molybdenum boride, molybdenum carbide, molybdenum silicide, molybdenum trioxide, nickel, platinum, silica (silicon dioxide), silver, SnCoC, titanium, titanium boride, titanium carbide, titanium dioxide, titanium nitride, titanium silicide, tungsten, tungsten boride, tungsten carbide, tungsten silicide, tungsten trioxide, vanadium silicide, zirconium boride, zirconium carbide, zirconium nitride, zirconium oxide, and combinations thereof.

In certain embodiments, the diluent or diluent subparticle is carbon. In certain embodiments, the diluent or diluent subparticle is a carbon subparticle. In certain embodiments, the diluent or diluent subparticle is a carbon nanoparticle. In certain embodiments, the diluent or diluent subparticle is a disordered carbon nanoparticle. In certain embodiments, the diluent or diluent subparticle is a graphite nanoparticle. In certain embodiments, the diluent or diluent subparticle is a carbon nanotube. In certain embodiments, the diluent or diluent subparticle is a carbon SWNT. In certain embodiments, the diluent or diluent subparticle is a carbon MWNT. In certain embodiments, the diluent or diluent subparticle is a carbon nanofiber.

In certain embodiments, the diluent or diluent subparticle is an Al nanoparticle or Ti nanoparticle.

In certain embodiments, the diluent or diluent subparticle has various shapes, including, but not limited to, sphere, spheroid, fibril, fiber, or platelet. In certain embodiments, the diluent or diluent subparticle is substantially spherical. In certain embodiments, the diluent or diluent subparticle is spherical.

In certain embodiments, the diluent or diluent subparticle has an average particle size ranging from about 10 nm to about 100 μm, from about 10 nm to about 10 μm, from about 20 nm to about 5 μm, from about 20 nm to about 1 um, from about 20 to about 500, from about 50 to about 500 nm, from about 50 to about 400 nm, from about 50 to about 200 nm, or from about 100 to about 200 nm. In certain embodiments, the diluent or diluent subparticle has an average particle size ranging about 50 nm, about 100 nm, about 150 nm, about 200 nm, about 300 nm, about 400 nm, about 500 nm, about 1 μm, about 2 μm, about 5 μm, or about 10 μm. In certain embodiments, the diluent or diluent subparticle has an average particle size ranging from about 10 to about 500 nm, from about 10 to about 200 nm, or from about 20 to about 100 nm.

Suitable binders include, but are not limited to, asphalt pitch, pitch coke, petroleum coke, sugars (e.g., sucrose), coal tar, fluoranthene, pyrene, chrysene, phenanthrene, anthracene, naphthalin, fluorine, biphenyl, acenephthene, solid ionic conductors, polymeric binders, and mixtures thereof.

In certain embodiments, the binder is asphalt pitch, pitch coke, petroleum coke, sugars, coal tar, fluoranthene, pyrene, chrysene, phenanthrene, anthracene, naphthalin, fluorine, biphenyl, or acenephthene, wherein the binder is subsequently carbonized, in one embodiment, in an inert gas atmosphere, so that the subparticles are coated with and/or bound together by a carbonized layer. In one embodiment, the amount of the carbonized binder in the non-spherical electroactive agglomerated particle is ranging from about 0.1 to about 20%, from about 0.5 to about 10%, or from about 1 to about 5% by weight of the non-spherical electroactive agglomerated particles. In certain embodiments, the inert gas that is used in the carbonization process is argon, nitrogen, or carbon dioxide. In certain embodiments, the carbonization is performed at a temperature ranging from about 250 to about 1,000° C., from about 300 to about 900° C., from about 400 to about 800° C., or from about 500 to about 700° C.

In certain embodiments, the binder is a solid ionic conductor. In certain embodiments, the binder is a solid ionic conductor selected from the group consisting of Li₃PO₄; a mixture of lithium nitride and lithium phosphate; a mixture of lithium phosphorus oxynitride and lithium phosphate; Li_{1+x+y}(Al, Ga)ₓ(Ti, Ge)₂₋ₓSi_{y}P_{3-y}O₁₂, where 0≦x≦1 and 0≦y≦1; and LiₓSi_{y}M_{z}OᵥN_{w}, where 0.3≦x≦0.46, 0.05≦y≦0.15, 0.016≦z≦0.05, 0.42≦v≦0.05, 0≦w≦0.029, and M is selected from the group consisting of Nb, Ta, and W.

In certain embodiments, the binder is an inorganic binder. In certain embodiments, the binder is an oxide, including, but not limited to, Al₂O₃, P₂O₅, LiPO₃, and mixtures thereof. In certain embodiments, the binder is Al₂O₃, P₂O₅, LiPO₃, or a mixture thereof.

In certain embodiments, the binder is an organic binder. In certain embodiments, the binder is a polymeric binder. Suitable polymeric binders include, but are not limited to, polyamideimides, polyimides, polytetrafluoroethylene (PTFE), carboxymethyl cellulose (CMC), polyvinylidene fluoride (PVDF), polyvinyl alcohol (PVA), styrene butadiene rubber (SBR), and mixtures thereof. In certain embodiments, the polymeric binder is a polyamideimide. In certain embodiments, the polymeric binder is a polyimide. In certain embodiments, the polymeric binder is carboxymethyl cellulose.

In certain embodiments, the binder is a crosslinkable polymeric binder. Suitable crosslinkable polymeric binders include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinkable polymeric binder is a polyamideimide. In certain embodiments, the crosslinkable polymeric binder is a polyimide. In certain embodiments, the crosslinkable polymeric binder is carboxymethyl cellulose.

In certain embodiments, the crosslinkable polymeric binder is a thermally crosslinkable polymeric binder. Suitable thermally crosslinkable polymeric binders include, but are not limited to, carboxymethyl celluloses (CMC), polyamideimides, polyimides, and mixtures thereof. In certain embodiments, the thermally crosslinkable polymeric binder is a polyamideimide. In certain embodiments, the thermally crosslinkable polymeric binder is a polyimide. In certain embodiments, the thermally crosslinkable polymeric binder is a carboxymethyl cellulose.

In certain embodiments, the crosslinkable polymeric binder is a photo-crosslinkable polymeric binder. Suitable photo-crosslinkable polymeric binders include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the binder is a crosslinked polymeric binder. Suitable crosslinked polymeric binders include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinked polymeric binder is a polyamideimide. In certain embodiments, the crosslinked polymeric binder is a polyimide. In certain embodiments, the crosslinked polymeric binder is carboxymethyl cellulose.

In certain embodiments, the crosslinked polymeric binder is a thermally crosslinked polymeric binder. Suitable thermally crosslinked polymeric binders include, but are not limited to, carboxymethyl celluloses (CMC), polyamideimides, polyimides, and mixtures thereof. In certain embodiments, the thermally crosslinked polymeric binder is a polyamideimide. In certain embodiments, the thermally crosslinked polymeric binder is a polyimide. In certain embodiments, the thermally crosslinked polymeric binder is a carboxymethyl cellulose.

In certain embodiments, the crosslinked polymeric binder is a photo-crosslinked polymeric binder. Suitable photo-crosslinked polymeric binders include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the polymeric binder is formed from its precursors via polymerization on the surface of the subparticles. In certain embodiments, the precursors of a polymer are monomers of the polymer. In certain embodiments, the polyamideimide as a polymeric binder is formed from a polyanhydride and a polyamine via polymerization on the surfaces of the subparticles. In certain embodiments, the polyimide as a polymeric binder is formed from a polyanhydride and a polyamine via polymerization on the surfaces of the subparticles. In certain embodiments, the precursors of a polymer are crosslinkable polymers. In certain embodiments, the polyamideimide as a polymeric binder is formed from a polyamideimide via crosslinking on the surface of the subparticles. In certain embodiments, the polyimide as a polymeric binder is formed from a polyimide via crosslinking on the surface of the subparticle.

In certain embodiments, the amount of the binder in the non-spherical electroactive agglomerated particle provided herein is ranging from about 0.1% to about 30%, from about 0.5% to about 20%, from about 1% to about 15%, from about 1% to about 10%, from about 1% to about 5%, or from about 2% to about 10% by weight of the non-spherical electroactive agglomerated particle. In certain embodiments, the amount of the binder in the non-spherical electroactive agglomerated particle provided herein is about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.5%, about 3%, about 3.5%, about 4%, about 4.5%, about 5%, about 10%, about 15%, about 20%, or about 25% by weight of the non-spherical electroactive agglomerated particle.

In certain embodiments, a conductive polymer is also added to the polymeric binder to increase the conductivity of the non-spherical electroactive agglomerated particle provided herein. Suitable conductive polymers include, but are not limited to, polythiophene, poly(3-hexylthiophene), poly(2-acetylthiophene), polybenzothiopnene, poly(2,5-dimethylthiophene), poly(2-ethylthiophene), poly(3-carboxylic ethyl thiophene), polythiopheneacetonitrile, poly(3,4-ethylenedioxythiophene), polyisothianaphthene, polypyrrole, polyaniline, polyparaphenylene, and mixtures thereof. In certain embodiments, the conductive polymer is added to the polymeric binder in an amount ranging from about 1 to about 40%, from about 2 to about 20%, from about 3 to about 15%, or from about 5 to about 10% by weight of the polymeric binder and conductive polymer. In certain embodiments, the conductive polymer is added to the polymeric binder first before contacting with the non-spherical electroactive agglomerated particle.

In certain embodiments, the non-spherical electroactive particle provided herein has various shapes, including, but not limited to, ellipsoid, discoid, toroid, fibril, fiber, or platelet. In certain embodiments, the non-spherical electroactive agglomerated particle provided herein is ellipsoidal. In certain embodiments, the non-spherical electroactive agglomerated particle provided herein is discoidal. In certain embodiments, the non-spherical electroactive agglomerated particle provided herein is toroidal. In certain embodiments, the non-spherical electroactive agglomerated particle provided herein has at least one flattened surface. In certain embodiments, the non-spherical electroactive agglomerated particle provided herein has at least one concave surface.

In certain embodiments, the non-spherical electroactive agglomerated particle provided herein is a micrometer-sized particle. Without being bound to any theory, such a micrometer-sized particle can increase the particle flowability, and manufacturability of end products, e.g., electrodes for a battery. In certain embodiments, the non-spherical electroactive agglomerated particle provided herein has an average particle size ranging from about 0.1 to about 100 μm, from about 0.5 to about 50 μm, from about 0.5 to about 20 μm, from about 1 to about 20 μm, from about 1 to about 10 μm, from about 2 to about 20 μm, from about 2 to about 10 μm, from about 3 to about 10 μm, from about 5 to about 12 μm, from about 6 to about 10 μm, from about 1 to about 5 μm, from about 2 to about 5 μm, or from about 3 to about 5 μm. In certain embodiments, the non-spherical electroactive agglomerated particle provided herein has an average particle size of about 1 μm, about 2 μm, about 3 μm, about 4 μm, about 5 μm, about 6 μm, about 7 μm, about 8 μm, about 9, or about 10 μm. In certain embodiments, the non-spherical electroactive agglomerated particle provided herein has an average particle size of about 3 μm. In certain embodiments, the non-spherical electroactive agglomerated particle provided herein has an average particle size of about 4 μm. In certain embodiments, the non-spherical electroactive agglomerated particle provided herein has an average particle size of about 5 μm. In certain embodiments, the non-spherical electroactive agglomerated particle provided herein has an average particle size of about 10 μm.

The particle sizes and particle size distributions of a particle or subparticle can be determined using any methods known to by one of ordinary skill in the art, including, but not limited to, laser light scattering and microscopic imaging.

In certain embodiments, the non-spherical electroactive agglomerated particle provided herein has an average surface area ranging from about 0.1 to about 100 m²/g, from about 1 to about 50 m²/g, from about 2 to about 20 m²/g, from about 5 to about 20 m²/g, from about 2 to about 15 m²/g, from about 2 to about 10 m²/g, or from about 10 to about 15 m²/g.

In certain embodiments, the non-spherical electroactive agglomerated particle provided herein is porous. In certain embodiments, the non-spherical electroactive agglomerated particle provided herein has porosity as measured by density, ranging from about 0.1 to about 10 g/cm³, from about 0.2 to about 5 g/cm³, from about 0.5 to about 4 g/cm³, or from about 1 to about 3 g/cm³. In certain embodiments, the non-spherical electroactive agglomerated particle provided herein has porosity of about 0.5, about 1, about 1.5, about 2, about 2.5, about 3, about 3.5, about 4, about, 4.5, or about 5 g/cm³.

In certain embodiments, the non-spherical electroactive agglomerated particles provided herein have such particle size distribution that 10% of the non-spherical electroactive agglomerated particles have a particle size of about 0.05 μm, about 0.1 μm, or about 1 μm; and 90% of the non-spherical electroactive agglomerated particles have a particle size of about 100 μm, about 50 μm, about 20 μm, about 10 μm, or about 5 μm. In certain embodiments, the non-spherical electroactive agglomerated particles provided herein have such particle size distribution that 10% of the non-spherical electroactive agglomerated particles have a particle size of 1 μm and 90% of the non-spherical electroactive agglomerated particles have a particle size of 10 μm.

In certain embodiments, the non-spherical electroactive agglomerated particle provided herein has a particle size ranging from about 100 nm to about 500 μm, from about 200 nm to about 200 μm, from about 500 nm to about 100 μm, from about 1 to about 50 μm, from about 10 to about 50 μm, from about 10 to about 40 μm, from about 10 to about 30 μm, or from about 10 to about 20 μm. In certain embodiments, the non-spherical electroactive agglomerated particle provided herein has a particle size in the range from about 1 to about 50 μm.

In certain embodiments, the non-spherical electroactive agglomerated particle provided herein is coated to provide additional desired chemical and/or physical properties, such as chemical inertness (by coating with metal oxides, such as TiO₂, MlO₃, WO₃, Al₂O₃, or ZnO) or electrical conductivity (by coating with, e.g., ionic conductors or carbon). In certain embodiments, the non-spherical electroactive agglomerated particle provided herein is coated with a metal oxide by mixing the non-spherical electroactive agglomerated particle with the metal oxide, e.g., in a grinder. In certain embodiments, the non-spherical electroactive agglomerated particle provided herein is coated with a metal oxide by mixing the non-spherical electroactive agglomerated particle with a solution of polytitanic acid, polytungstic acid, polymolybdic acid, polytitanic acid peroxide, polytungstic acid peroxide, polymolybdic acid peroxide, or a mixture thereof, to form the corresponding metal oxide upon dehydration.

In certain embodiments, the non-spherical electroactive agglomerated particle provided herein is coated with carbon by thermal vapor deposition (CVD), as described in U.S. Pat. App. Pub. No. 2003/025711, the disclosure of which is incorporated herein by reference in its entirety.

In one embodiment, the non-spherical electroactive agglomerated particle comprises an electroactive material and a binder. In certain embodiments, the non-spherical electroactive agglomerated particle provided herein comprises from about 50 to about 99% by weight of the electroactive material and from about 50 to about 1% by weight of the binder, with the proviso that the total is no greater than 100%. In certain embodiments, the non-spherical electroactive agglomerated particle provided herein comprises from about 75 to about 99% by weight of the electroactive material and from about 25 to about 1% by weight of the binder, with the proviso that the total is no greater than 100%. In certain embodiments, the non-spherical electroactive agglomerated particle provided herein comprises from about 90 to about 99% by weight of the electroactive material and from about 10 to about 1% by weight of the binder, with the proviso that the total is no greater than 100%.

In one embodiment, the non-spherical electroactive agglomerated particle comprises subparticles of an electroactive material and a binder. In certain embodiments, the non-spherical electroactive agglomerated particle provided herein comprises from about 50 to about 99% by weight of subparticles of the electroactive material and from about 50 to about 1% by weight of the binder, with the proviso that the total is no greater than 100%. In certain embodiments, the non-spherical electroactive agglomerated particle provided herein comprises from about 75 to about 99% by weight of subparticles of the electroactive material and from about 25 to about 1% by weight of the binder, with the proviso that the total is no greater than 100%. In certain embodiments, the non-spherical electroactive agglomerated particle provided herein comprises from about 90 to about 99% by weight of subparticles of the electroactive material and from about 10 to about 1% by weight of the binder, with the proviso that the total is no greater than 100%.

In one embodiment, the non-spherical electroactive agglomerated particle comprises a first and second electroactive material.

In certain embodiments, the non-spherical electroactive agglomerated particle provided herein comprises from about 1 to about 99%, from about 5 to about 95%, from about 30 to about 95%, from about 50 to about 90%, from about 60% to about 90%, from about 60% to about 80%, from about 65% to about 80%, from about 70% to about 80%, or from about 80% to 90% by weight of the first electroactive material; and from about 99 to about 1%, from about 95 to about 5%, from about 70 to about 5%, from about 50 to about 10%, from about 40 to about 10%, from about 40 to about 20%, from about 35 to about 20%, from about 30 to about 20%, or from about 20 to about 10% by weight of the second electroactive material, with the proviso that the total is no greater than 100%.

In one embodiment, the non-spherical electroactive agglomerated particle provided herein comprises from about 5 to about 95% by weight of the first electroactive material and from about 95 to about 5% by weight of the second electroactive material, with the proviso that the total is no greater than 100%.

In another embodiment, the non-spherical electroactive agglomerated particle provided herein comprises from about 30 to about 95% by weight of the first electroactive material and from about 70 to about 5% by weight of the second electroactive material, with the proviso that the total is no greater than 100%.

In yet another embodiment, the non-spherical electroactive agglomerated particle provided herein comprises from about 50 to about 90% by weight of the first electroactive material and from about 50 to about 10% by weight of the second electroactive material with the proviso that the total is no greater than 100%.

In yet another embodiment, the non-spherical electroactive agglomerated particle provided herein comprises from about 60 to about 90% by weight of the first electroactive material and from about 40 to about 10% by weight of the second electroactive material with the proviso that the total is no greater than 100%.

In yet another embodiment, the non-spherical electroactive agglomerated particle provided herein comprises from about 60 to about 80% by weight of the first electroactive material and from about 40 to about 20% by weight of the second electroactive material with the proviso that the total is no greater than 100%.

In one embodiment, the non-spherical electroactive agglomerated particle comprises subparticles of a first electroactive material and subparticles of a second electroactive material.

In one embodiment, the non-spherical electroactive agglomerated particle provided herein comprises from about 5 to about 95% by weight of subparticles of the first electroactive material and from about 95 to about 5% by weight of subparticles of the second electroactive material, with the proviso that the total is no greater than 100%.

In another embodiment, the non-spherical electroactive agglomerated particle provided herein comprises from about 30 to about 95% by weight of subparticles of the first electroactive material and from about 70 to about 5% by weight of subparticles of the second electroactive material, with the proviso that the total is no greater than 100%.

In yet another embodiment, the non-spherical electroactive agglomerated particle provided herein comprises from about 50 to about 90% by weight of subparticles of the first electroactive material and from about 50 to about 10% by weight of subparticles of the second electroactive material with the proviso that the total is no greater than 100%.

In yet another embodiment, the non-spherical electroactive agglomerated particle provided herein comprises from about 60 to about 90% by weight of subparticles of the first electroactive material and from about 40 to about 10% by weight of subparticles of the second electroactive material with the proviso that the total is no greater than 100%.

In yet another embodiment, the non-spherical electroactive agglomerated particle provided herein comprises from about 60 to about 80% by weight of subparticles of the first electroactive material and from about 40 to about 20% by weight of subparticles of the second electroactive material with the proviso that the total is no greater than 100%.

In yet another embodiment, the non-spherical electroactive agglomerated particle comprises a first and second electroactive material, and a binder.

In one embodiment, the non-spherical electroactive agglomerated particle provided herein comprises from about 5 to about 95% by weight of the first electroactive material, from about 95 to about 5% by weight of the second electroactive material, and from about 0.1 to about 5% by weight of the binder, with the proviso that the total is no greater than 100%.

In another embodiment, the non-spherical electroactive agglomerated particle provided herein comprises from about 30 to about 95% by weight of the first electroactive material, from about 70 to about 5% by weight of the second electroactive material, and from about 0.1 to about 5% by weight of the binder, with the proviso that the total is no greater than 100%.

In yet another embodiment, the non-spherical electroactive agglomerated particle provided herein comprises from about 50 to about 90% by weight of the first electroactive material and from about 50 to about 10% by weight of the second electroactive material, and from about 0.1 to about 5% by weight of the binder, with the proviso that the total is no greater than 100%.

In yet another embodiment, the non-spherical electroactive agglomerated particle provided herein comprises from about 60 to about 90% by weight of the first electroactive material and from about 40 to about 10% by weight of the second electroactive material, and from about 0.1 to about 5% by weight of the binder, with the proviso that the total is no greater than 100%.

In yet another embodiment, the non-spherical electroactive agglomerated particle provided herein comprises from about 60 to about 80% by weight of the first electroactive material and from about 40 to about 20% by weight of the second electroactive material, and from about 0.1 to about 5% by weight of the binder, with the proviso that the total is no greater than 100%.

In yet another embodiment, the non-spherical electroactive agglomerated particle comprises subparticles of a first electroactive material, subparticles of a second electroactive material, and a binder.

In one embodiment, the non-spherical electroactive agglomerated particle provided herein comprises from about 5 to about 95% by weight of subparticles of the first electroactive material, from about 95 to about 5% by weight of subparticles of the second electroactive material, and from about 0.1 to about 5% by weight of the binder, with the proviso that the total is no greater than 100%.

In another embodiment, the non-spherical electroactive agglomerated particle provided herein comprises from about 30 to about 95% by weight of subparticles of the first electroactive material, from about 70 to about 5% by weight of subparticles of the second electroactive material, and from about 0.1 to about 5% by weight of the binder, with the proviso that the total is no greater than 100%.

In yet another embodiment, the non-spherical electroactive agglomerated particle provided herein comprises from about 50 to about 90% by weight of subparticles of the first electroactive material and from about 50 to about 10% by weight of subparticles of the second electroactive material, and from about 0.1 to about 5% by weight of the binder, with the proviso that the total is no greater than 100%.

In yet another embodiment, the non-spherical electroactive agglomerated particle provided herein comprises from about 60 to about 90% by weight of subparticles of the first electroactive material and from about 40 to about 10% by weight of subparticles of the second electroactive material, and from about 0.1 to about 5% by weight of the binder, with the proviso that the total is no greater than 100%.

In yet another embodiment, the non-spherical electroactive agglomerated particle provided herein comprises from about 60 to about 80% by weight of subparticles of the first electroactive material and from about 40 to about 20% by weight of subparticles of the second electroactive material, and from about 0.1 to about 5% by weight of the binder, with the proviso that the total is no greater than 100%.

a. Non-Spherical Electroactive Agglomerated Particle for a Anode

In one embodiment, provided herein is a non-spherical electroactive agglomerated particle that comprises silicon, and optionally a binder. In another embodiment, provided herein is a non-spherical electroactive agglomerated particle comprising subparticles of silicon, and optionally a binder.

In one embodiment, the binder is a polymer. In another embodiment, the binder is a crosslinkable polymer. In yet another embodiment, the binder is a polyamideimide or polyimide. In yet another embodiment, the binder is TORLON® AI-30, TORLON® AI-50, TORLON® 4000, or TORLON® 4203L. In yet another embodiment, the polymeric binder is formed in situ from precursors of the polymer on the surface of an electroactive subparticle. In yet another embodiment, the precursors are U-VARNISH®.

In one embodiment, provided herein is a non-spherical electroactive agglomerated particle comprising silicon and TORLON® AI-50. In another embodiment, provided herein is a non-spherical electroactive agglomerated particle comprising silicon subparticles and TORLON® AI-50. In yet another embodiment, provided herein is a non-spherical electroactive agglomerated particle comprising from about 75% by weight of silicon and about 25% by weight of TORLON® AI-50 [INVENTORS, PLEASE CHECK THE RATIO]. In still another embodiment, provided herein is a non-spherical electroactive agglomerated particle comprising from about 75% by weight of subparticles of silicon, and about 25% by weight of TORLON® AI-50. In certain embodiments, the non-spherical electroactive agglomerated particle provided herein is toroidal. In certain embodiments, the volume change of the non-spherical electroactive agglomerated particle during a charging/discharging cycle is no more than 200%.

b. Electroactive Agglomerated Particle for a Cathode

In one embodiment, provided herein is a non-spherical electroactive agglomerated particle, that comprises at least one electroactive materials, and optionally a binder. In another embodiment, provided herein is a non-spherical electroactive agglomerated particle, that comprises at least two electroactive materials, and optionally a binder.

In one embodiment, provided herein is a non-spherical electroactive agglomerated particle, that comprises a first and second electroactive material, and a binder. In another embodiment, the non-spherical electroactive agglomerated particle comprises about 5 to about 95% by weight of the first electroactive material, from about 95 to about 5% by weight of the second electroactive material, and from about 0.1 to about 20% by weight of the binder, with the proviso that the total is no greater than 100%. In yet another embodiment, the non-spherical electroactive agglomerated particle comprises about 50 to about 95% by weight of the first electroactive material, from about 50 to about 5% by weight of the second electroactive material, and from about 0.1 to about 10% by weight of the binder, with the proviso that the total is no greater than 100%. In yet another embodiment, the non-spherical electroactive agglomerated particle comprises about 60 to about 80% by weight of the first electroactive material, from about 40 to about 20% by weight of the second electroactive material, and from about 0.1 to about 5% by weight of the binder, with the proviso that the total is no greater than 100%. In yet another embodiment, the non-spherical electroactive agglomerated particle comprises about 70% by weight of the first electroactive material, about 30% by weight of the second electroactive material, and about 1% by weight of the binder, with the proviso that the total is no greater than 100%.

In one embodiment, the non-spherical electroactive agglomerated particle comprises subparticles of the first electroactive material, subparticles of the second electroactive material, and the binder. In another embodiment, the non-spherical electroactive agglomerated particle comprises about 5 to about 95% by weight of subparticles of the first electroactive material, from about 95 to about 5% by weight of subparticles of the second electroactive material, and from about 0.1 to about 20% by weight of the binder, with the proviso that the total is no greater than 100%. In yet another embodiment, the non-spherical electroactive agglomerated particle comprises about 50 to about 95% by weight of subparticles of the first electroactive material, from about 50 to about 5% by weight of subparticles of the second electroactive material, and from about 0.1 to about 10% by weight of the binder, with the proviso that the total is no greater than 100%. In yet another embodiment, the non-spherical electroactive agglomerated particle comprises about 60 to about 80% by weight of subparticles of the first electroactive material, from about 40 to about 20% by weight of subparticles of the second electroactive material, and from about 0.1 to about 5% by weight of the binder, with the proviso that the total is no greater than 100%. In yet another embodiment, the non-spherical electroactive agglomerated particle comprises about 70% by weight of subparticles of the first electroactive material, about 30% by weight of subparticles of the second electroactive material, and about 1% by weight of the binder, with the proviso that the total is no greater than 100%.

In certain embodiments, the non-spherical electroactive agglomerated particle further comprises a diluent.

In one embodiment, the non-spherical electroactive agglomerated particle comprises the first electroactive material, the second electroactive material, the binder, and the diluent. In another embodiment, the non-spherical electroactive agglomerated particle comprises about 5 to about 95% by weight of the first electroactive material, from about 95 to about 5% by weight of the second electroactive material, from about 0.1 to about 20% by weight of the binder, and from about 1 to about 20% by weight of the diluent, with the proviso that the total is no greater than 100%. In yet another embodiment, the non-spherical electroactive agglomerated particle comprises about 50 to about 95% by weight of the first electroactive material, from about 50 to about 5% by weight of the second electroactive material, from about 0.1 to about 10% by weight of the binder, and from about 1 to about 15% by weight of the diluent, with the proviso that the total is no greater than 100%. In yet another embodiment, the non-spherical electroactive agglomerated particle comprises about 60 to about 80% by weight of the first electroactive material, from about 40 to about 20% by weight of the second electroactive material, from about 0.1 to about 5% by weight of the binder, and from about 1 to about 10% by weight of the diluent, with the proviso that the total is no greater than 100%. In yet another embodiment, the non-spherical electroactive agglomerated particle comprises about 70% by weight of the first electroactive material, 30% by weight of the second electroactive material, 1% by weight of the binder, and about 5% by weight of the diluent, with the proviso that the total is no greater than 100%.

In one embodiment, the non-spherical electroactive agglomerated particle comprises subparticles of the first electroactive material, subparticles of the second electroactive material, the binder, and the diluent. In another embodiment, the non-spherical electroactive agglomerated particle comprises about 5 to about 95% by weight of subparticles of the first electroactive material, from about 95 to about 5% by weight of subparticles of the second electroactive material, from about 0.1 to about 20% by weight of the binder, and from about 1 to about 20% by weight of the diluent, with the proviso that the total is no greater than 100%. In yet another embodiment, the non-spherical electroactive agglomerated particle comprises about 50 to about 95% by weight of subparticles of the first electroactive material, from about 50 to about 5% by weight of subparticles of the second electroactive material, from about 0.1 to about 10% by weight of the binder, and from about 1 to about 15% by weight of the diluent, with the proviso that the total is no greater than 100%. In yet another embodiment, the non-spherical electroactive agglomerated particle comprises about 60 to about 80% by weight of subparticles of the first electroactive material, from about 40 to about 20% by weight of subparticles of the second electroactive material, from about 0.1 to about 5% by weight of the binder, and from about 1 to about 10% by weight of the diluent, with the proviso that the total is no greater than 100%. In yet another embodiment, the non-spherical electroactive agglomerated particle comprises about 70% by weight of subparticles of the first electroactive material, 30% by weight of subparticles of the second electroactive material, 1% by weight of the binder, and about 5% by weight of the diluent, with the proviso that the total is no greater than 100%.

In one embodiment, the non-spherical electroactive agglomerated particle comprises LiFePO₄ or LiMn₂O₄ as the first electroactive material, LiNiCoAlO₂ as the second electroactive material, and a binder. In another embodiment, the non-spherical electroactive agglomerated particle comprises subparticles of LiFePO₄ or LiMn₂O₄, subparticles of LiNiCoAlO₂, and a binder.

In one embodiment, the binder is a polymer. In another embodiment, the binder is a crosslinkable polymer. In yet another embodiment, the binder is a polyamideimide or polyimide. In yet another embodiment, the binder is TORLON® AI-30, TORLON® AI-50, TORLON® 4000, or TORLON® 4203L. In yet another embodiment, the polymeric binder is formed in situ from precursors of the polymer on the surface of an electroactive subparticle. In yet another embodiment, the precursors are U-VARNISH®.

In one embodiment, the diluent is carbon. In another embodiment, the diluent is sucrose.

In one embodiment, the non-spherical electroactive agglomerated particle comprises LiFePO₄, LiNiCoAlO₂, and TORLON® AI-50. In another embodiment, the non-spherical electroactive agglomerated particle comprises about 5 to about 95% by weight of LiFePO₄, from about 95 to about 5% by weight of LiNiCoAlO₂, and from about 0.1 to about 20% by weight of TORLON® AI-50, with the proviso that the total is no greater than 100%. In yet another embodiment, the non-spherical electroactive agglomerated particle comprises about 50 to about 95% by weight of LiFePO₄, from about 50 to about 5% by weight of LiNiCoAlO₂, and from about 0.1 to about 10% by weight of TORLON® AI-50, with the proviso that the total is no greater than 100%. In yet another embodiment, the non-spherical electroactive agglomerated particle comprises about 60 to about 80% by weight of LiFePO₄, from about 40 to about 20% by weight of LiNiCoAlO₂, and from about 0.1 to about 5% by weight of TORLON® AI-50, with the proviso that the total is no greater than 100%. In yet another embodiment, the non-spherical electroactive agglomerated particle comprises about 70% by weight of LiFePO₄, about 30% by weight of LiNiCoAlO₂, and about 1% by weight of TORLON® AI-50, with the proviso that the total is no greater than 100%.

In one embodiment, the non-spherical electroactive agglomerated particle comprises subparticles of LiFePO₄, subparticles of LiNiCoAlO₂, and TORLON® AI-50. In another embodiment, the non-spherical electroactive agglomerated particle comprises about 5 to about 95% by weight of subparticles of LiFePO₄, from about 95 to about 5% by weight of subparticles of LiNiCoAlO₂, and from about 0.1 to about 20% by weight of TORLON® AI-50, with the proviso that the total is no greater than 100%. In yet another embodiment, the non-spherical electroactive agglomerated particle comprises about 50 to about 95% by weight of subparticles of LiFePO₄, from about 50 to about 5% by weight of subparticles of LiNiCoAlO₂, and from about 0.1 to about 10% by weight of TORLON® AI-50, with the proviso that the total is no greater than 100%. In yet another embodiment, the non-spherical electroactive agglomerated particle comprises about 60 to about 80% by weight of subparticles of LiFePO₄, from about 40 to about 20% by weight of subparticles of LiNiCoAlO₂, and from about 0.1 to about 5% by weight of TORLON® AI-50, with the proviso that the total is no greater than 100%. In yet another embodiment, the non-spherical electroactive agglomerated particle comprises about 70% by weight of subparticles of LiFePO₄, about 30% by weight of subparticles of LiNiCoAlO₂, and about 1% by weight of TORLON® AI-50, with the proviso that the total is no greater than 100%.

In one embodiment, the non-spherical electroactive agglomerated particle comprises LiFePO₄, LiNiCoAlO₂, TORLON® AI-50, and sucrose. In another embodiment, the non-spherical electroactive agglomerated particle comprises about 5 to about 95% by weight of LiFePO₄, from about 95 to about 5% by weight of LiNiCoAlO₂, from about 0.1 to about 20% by weight of TORLON® AI-50, and from about 1 to about 20% by weight of sucrose, with the proviso that the total is no greater than 100%. In yet another embodiment, the non-spherical electroactive agglomerated particle comprises about 50 to about 95% by weight of LiFePO₄, from about 50 to about 5% by weight of LiNiCoAlO₂, from about 0.1 to about 10% by weight of TORLON® AI-50, and from about 1 to about 15% by weight of sucrose, with the proviso that the total is no greater than 100%. In yet another embodiment, the non-spherical electroactive agglomerated particle comprises about 60 to about 80% by weight of LiFePO₄, from about 40 to about 20% by weight of LiNiCoAlO₂, from about 0.1 to about 5% by weight of TORLON® AI-50, and from about 1 to about 10% by weight of sucrose, with the proviso that the total is no greater than 100%. In yet another embodiment, the non-spherical electroactive agglomerated particle comprises about 70% by weight of LiFePO₄, 30% by weight of LiNiCoAlO₂, 1% by weight of TORLON® AI-50, and about 5% by weight of sucrose, with the proviso that the total is no greater than 100%.

In one embodiment, the non-spherical electroactive agglomerated particle comprises subparticles of LiFePO₄, subparticles of LiNiCoAlO₂, TORLON® AI-50, and sucrose. In another embodiment, the non-spherical electroactive agglomerated particle comprises about 5 to about 95% by weight of subparticles of LiFePO₄, from about 95 to about 5% by weight of subparticles of LiNiCoAlO₂, from about 0.1 to about 20% by weight of TORLON® AI-50, and from about 1 to about 20% by weight of sucrose, with the proviso that the total is no greater than 100%. In yet another embodiment, the non-spherical electroactive agglomerated particle comprises about 50 to about 95% by weight of subparticles of LiFePO₄, from about 50 to about 5% by weight of subparticles of LiNiCoAlO₂, from about 0.1 to about 10% by weight of TORLON® AI-50, and from about 1 to about 15% by weight of sucrose, with the proviso that the total is no greater than 100%. In yet another embodiment, the non-spherical electroactive agglomerated particle comprises about 60 to about 80% by weight of subparticles of LiFePO₄, from about 40 to about 20% by weight of subparticles of LiNiCoAlO₂, from about 0.1 to about 5% by weight of TORLON® AI-50, and from about 1 to about 10% by weight of sucrose, with the proviso that the total is no greater than 100%. In yet another embodiment, the non-spherical electroactive agglomerated particle comprises about 70% by weight of subparticles of LiFePO₄, 30% by weight of subparticles of LiNiCoAlO₂, 1% by weight of TORLON® AI-50, and about 5% by weight of sucrose, with the proviso that the total is no greater than 100%.

In one embodiment, the non-spherical electroactive agglomerated particle comprises LiFePO₄, LiNiCoAlO₂, TORLON® AI-50, and carbon. In another embodiment, the non-spherical electroactive agglomerated particle comprises about 5 to about 95% by weight of LiFePO₄, from about 95 to about 5% by weight of LiNiCoAlO₂, from about 0.1 to about 20% by weight of TORLON® AI-50, and from about 1 to about 20% by weight of carbon, with the proviso that the total is no greater than 100%. In yet another embodiment, the non-spherical electroactive agglomerated particle comprises about 50 to about 95% by weight of LiFePO₄, from about 50 to about 5% by weight of LiNiCoAlO₂, from about 0.1 to about 10% by weight of TORLON® AI-50, and from about 1 to about 15% by weight of carbon, with the proviso that the total is no greater than 100%. In yet another embodiment, the non-spherical electroactive agglomerated particle comprises about 60 to about 80% by weight of LiFePO₄, from about 40 to about 20% by weight of LiNiCoAlO₂, from about 0.1 to about 5% by weight of TORLON® AI-50, and from about 1 to about 10% by weight of carbon, with the proviso that the total is no greater than 100%. In yet another embodiment, the non-spherical electroactive agglomerated particle comprises about 70% by weight of LiFePO₄, 30% by weight of LiNiCoAlO₂, 1% by weight of TORLON® AI-50, and about 5% by weight of carbon, with the proviso that the total is no greater than 100%.

In one embodiment, the non-spherical electroactive agglomerated particle comprises subparticles of LiFePO₄, subparticles of LiNiCoAlO₂, TORLON® AI-50, and carbon. In another embodiment, the non-spherical electroactive agglomerated particle comprises about 5 to about 95% by weight of subparticles of LiFePO₄, from about 95 to about 5% by weight of subparticles of LiNiCoAlO₂, from about 0.1 to about 20% by weight of TORLON® AI-50, and from about 1 to about 20% by weight of carbon, with the proviso that the total is no greater than 100%. In yet another embodiment, the non-spherical electroactive agglomerated particle comprises about 50 to about 95% by weight of subparticles of LiFePO₄, from about 50 to about 5% by weight of subparticles of LiNiCoAlO₂, from about 0.1 to about 10% by weight of TORLON® AI-50, and from about 1 to about 15% by weight of carbon, with the proviso that the total is no greater than 100%. In yet another embodiment, the non-spherical electroactive agglomerated particle comprises about 60 to about 80% by weight of subparticles of LiFePO₄, from about 40 to about 20% by weight of subparticles of LiNiCoAlO₂, from about 0.1 to about 5% by weight of TORLON® AI-50, and from about 1 to about 10% by weight of carbon, with the proviso that the total is no greater than 100%. In yet another embodiment, the non-spherical electroactive agglomerated particle comprises about 70% by weight of subparticles of LiFePO₄, 30% by weight of subparticles of LiNiCoAlO₂, 1% by weight of TORLON® AI-50, and about 5% by weight of carbon, with the proviso that the total is no greater than 100%.

In one embodiment, the non-spherical electroactive agglomerated particle comprises LiMn₂O₄, LiNiCoAlO₂, and TORLON® AI-50. In another embodiment, the non-spherical electroactive agglomerated particle comprises about 5 to about 95% by weight of LiMn₂O₄, from about 95 to about 5% by weight of LiNiCoAlO₂, and from about 0.1 to about 20% by weight of TORLON® AI-50, with the proviso that the total is no greater than 100%. In yet another embodiment, the non-spherical electroactive agglomerated particle comprises about 50 to about 95% by weight of LiMn₂O₄, from about 50 to about 5% by weight of LiNiCoAlO₂, and from about 0.1 to about 10% by weight of TORLON® AI-50, with the proviso that the total is no greater than 100%. In yet another embodiment, the non-spherical electroactive agglomerated particle comprises about 60 to about 80% by weight of LiMn₂O₄, from about 40 to about 20% by weight of LiNiCoAlO₂, and from about 0.1 to about 5% by weight of TORLON® AI-50, with the proviso that the total is no greater than 100%. In yet another embodiment, the non-spherical electroactive agglomerated particle comprises about 70% by weight of LiMn₂O₄, 30% by weight of LiNiCoAlO₂, and 1% by weight of TORLON® AI-50, with the proviso that the total is no greater than 100%.

In one embodiment, the non-spherical electroactive agglomerated particle comprises subparticles of LiMn₂O₄, subparticles of LiNiCoAlO₂, and TORLON® AI-50. In another embodiment, the non-spherical electroactive agglomerated particle comprises about 5 to about 95% by weight of subparticles of LiMn₂O₄, from about 95 to about 5% by weight of subparticles of LiNiCoAlO₂, and from about 0.1 to about 20% by weight of TORLON® AI-50, with the proviso that the total is no greater than 100%. In yet another embodiment, the non-spherical electroactive agglomerated particle comprises about 50 to about 95% by weight of subparticles of LiMn₂O₄, from about 50 to about 5% by weight of subparticles of LiNiCoAlO₂, and from about 0.1 to about 10% by weight of TORLON® AI-50, with the proviso that the total is no greater than 100%. In yet another embodiment, the non-spherical electroactive agglomerated particle comprises about 60 to about 80% by weight of subparticles of LiMn₂O₄, from about 40 to about 20% by weight of subparticles of LiNiCoAlO₂, and from about 0.1 to about 5% by weight of TORLON® AI-50, with the proviso that the total is no greater than 100%. In yet another embodiment, the non-spherical electroactive agglomerated particle comprises about 70% by weight of subparticles of LiMn₂O₄, 30% by weight of subparticles of LiNiCoAlO₂, and 1% by weight of TORLON® AI-50, with the proviso that the total is no greater than 100%.

### Electroactive Materials

a. Electroactive Materials for an Anode

In certain embodiments, the electroactive material for an anode is an electroactive metal or metal oxide. Suitable electroactive metals and metal oxides include, but are not limited to, silicon (Si), silicon monoxide (SiO), Si₂N₂O, Ge₂N₂O, boron oxide, titanium oxides (including titanium monoxide, titanium(III) oxide, and titanium dioxide), tin, tin oxides (including tin(II) oxide (SnO) and tin dioxide (SnO₂)), antimony, magnesium, zinc, zirconium oxide, cadmium, indium, aluminum, bismuth, germanium, lead, vanadium oxide, cobalt oxide, W0₂, and combinations thereof, In certain embodiments, the electroactive material for an anode is Li₄Ti₅O₁₂, Si₇₀Fe₁₀Ti₁₀C₁₀, to, TiS₂, MoS₂, and combina certain embodiments, the electroactive material for an anode is Si, SiO, Li₄Ti₅O₁₂, SnO, WO₂, Si₇₀Fe₁₀Ti₂₀C₁₀, TiS₂, MoS₂, WS₂, or a mixture thereof.

In certain embodiments, the electroactive material for an anode is an electroactive alloy. Suitable electrochemically active alloys include, but are not limited to, silicon alloys containing tin, a transition metal, and optionally carbon; silicon alloys containing a transition metal and aluminum; silicon alloys containing copper and silver; and alloys containing tin, silicon, or aluminum, yttrium, and a lanthanide or an actinide or a combination thereof. In certain embodiments, the electrochemically active alloy is SnSb, SnAg, AgSi, GaSb, AlSb, InSb, Sb₂Ti, Sb₂V, Sn₂Sn, Cu₂Sb, Cr₂Sb, or a mixture thereof. In certain embodiments, the electrochemically active alloy is a multiple phase alloy, including, but not limited to, Sn/SnSbₓ, Sn/SnAgₓ, SnF/SnFeC, and SnMnC, wherein each x is independently greater than 0 but smaller than about 10, in one embodiment, about 0.1, about 0.2, about 0.5, about 1, about 2, about 3, about 4, about 5, about 6, about 7, about 8, about 9, or about 10. In certain embodiments, SnSb is SnSb_{0.39}. In certain embodiments, SnAg is SnAg_{0.1}, SnAg_{0.32}, SnAg_{0.39}, SnAg₃, or SnAg₄. In certain embodiments, the electroactive material used herein is silicon. In certain embodiments, the silicon is doped with boron, aluminum, gallium, antimony, phosphorus, or a combination thereof. In certain embodiments, the electroactive material used herein comprises silicon, in one embodiment, silicon powder, and carbon. In certain embodiments, the electroactive material used herein comprises silicon, in one embodiment, silicon powder, and carbon.

b. Electroactive Materials for a Cathode

In certain embodiments, the electroactive material for a cathode is a lithium compound. In one embodiment, the electroactive material is a lithium phosphate compound. In another embodiment, the electroactive material is LiMPO₄, wherein M is a transition metal. In certain embodiments, M is a transition metal selected from the group consisting of Ti, V, Cr, Mn, Fe, Co, and Ni. In yet another embodiment, the electroactive material is LiFePO₄. In yet another embodiment, the electroactive material is LiMnPO₄. In yet another embodiment, the electroactive material is LiVPO₄. In yet another embodiment, the electroactive material is AM^{a}_{1-d}M^{b}_{d}PO₄, wherein A is Li, Na, or a mixture thereof; M^{a} is Fe, Co, Mn, or a mixture thereof; M^{b} is Mg, Ca, Zn, Ni, Co, Cu, Al, B, Cr, Nb, or a mixture thereof; and d is ranging from about 0.01 to about 0.99, from about 0.01 to about 0.5, from about 0.01 to about 0.30, or from about 0.01 to about 0.15. In yet another embodiment, the electroactive material is LiM^{a}_{1-d}M^{b}_{d}PO₄, wherein M^{a}, M^{b}, and d are each as defined herein. In still another embodiment, the electroactive material is NaM^{a}₁₋ₐM^{b}_{d}PO₄, wherein M^{a}, M^{b}, and d are each as defined herein.

In certain embodiments, the electroactive material is (LiF)ₓFe₁₋ₓ, wherein 0<x<1.

In certain embodiments, the electroactive material for a cathode is a metal oxide. In one embodiment, the electroactive material is selected from the group consisting of LiMn₂O₄, LiCoO₂, LiNiCoO₂, LiN_{c}Co_{1-c}O₂, where c is from about 0.05 to about 0.95, from about 0.1 to about 0.90, from about 0.2 to about 0.5, or from about 0.2 to about 0.4, Li(NiMnCo)_{1/3}O₂, Li(NiMn)_{1/2}O₂, LiV₂O₅, LiAlNiCoO₂, LiN_{1-a-b}AlₐCo_{b}O₂, where a is from about 0.01 to about 0.5 and b is from about 0.01 to about 0.9, with the proviso that the sum of a and b is less than 1; and c is from about 0.01 to about 0.99, and mixtures thereof. In one embodiment, the electroactive material is LiMn₂O₄ In another embodiment, the electroactive material is LiCoO₂ In yet another embodiment, the electroactive material is LiNiCoO₂. In yet another embodiment, the electroactive material is LiNi_{c}Co_{1-c}O₂, wherein c is from about 0.2 to about 0.5, from about 0.2 to about 0.4, or about 0.3. In yet another embodiment, the electroactive material is Li(NiMnCo)_{1/3}O₂. In yet another embodiment, the electroactive material is Li(NiMn)_{1/2}O₂. In yet another embodiment, the electroactive material is LiV₂O₅.

In still another embodiment, the electroactive material is LiAlNiCoO₂.

In yet another embodiment, the electroactive material for a cathode is LiNiₑMn_{f}CO_{1-e-f}O₂, wherein e and f are each independently ranging from 0 to about 0.95, from about 0.01 to about 0.9, from about 0.05 to about 0.80, from about 0.1 to about 0.5, or from about 0.2 to about 0.4, and the sum of e and f is less than 1. In yet another embodiment, the electroactive material is LiNiₑMn_{f}Co_{1-e-f}O₂, wherein e and f are 0.33.

In still another embodiment, the electroactive material for a cathode is LiNi_{1-a-b}AlₐCo_{b}O₂, wherein a is from about 0.01 to about 0.9, from about 0.01 to about 0.7, from about 0.01 to about 0.5, from about 0.01 to about 0.4, from about 0.01 to about 0.3, from about 0.01 to about 0.2, or from about 0.01 to about 0.1; and b is from about 0.01 to about 0.9, from about 0.01 to about 0.7, from about 0.01 to about 0.5, from about 0.01 to about 0.4, from about 0.01 to about 0.3, from about 0.01 to about 0.2, or from about 0.01 to about 0.1; with the proviso that the sum of a and b is less than 1. In certain embodiments, a is from about 0.01 to about 0.5. In certain embodiments, a is from about 0.01 to about 0.1. In certain embodiments, b is from about 0.01 to about 0.9. In certain embodiments, b is from about 0.01 to about 0.2. In certain embodiments, a is from about 0.01 to about 0.1 and b is from about 0.01 to about 0.2. In certain embodiments, the electroactive material is LiAl_{0.05}Ni_{0.8}Co_{0.15}O₂.

### Eleectroaactive Subparticles

a. Electroactive Subparticles for an Anode

In one embodiment, the electroactive subparticle used herein comprises one or more electroactive materials, which are as defined herein. In another embodiment, the electroactive subparticle used herein comprises one electroactive material, which is as defined herein. In yet another embodiment, the electroactive subparticle used herein comprises two electroactive materials, which are as defined herein. In yet another embodiment, the electroactive subparticle used herein is an embedded subparticle that comprises two or more electroactive materials, which are as defined herein. In yet another embodiment, the electroactive subparticle used herein is an embedded subparticle that comprises two electroactive materials, wherein one of the electroactive materials is embedded in the other electroactive material.

In certain embodiments, the electroactive subparticle used herein comprises silicon, in one embodiment, silicon powder. In certain embodiments, the electroactive subparticle consists essentially of silicon, in one embodiment, silicon powder. In certain embodiments, the silicon subparticle is doped with boron, aluminum, gallium, antimony, phosphorus, or a combination thereof.

In certain embodiments, the electroactive subparticle used herein comprises i) silicon, in one embodiment, silicon powder, and ii) carbon.

In certain embodiments, the electroactive subparticle used herein is isotropic. In certain embodiments, the electroactive subparticle used herein is homogeneous. In certain embodiments, the electroactive subparticle used herein is isotropic and homogenous.

In certain embodiments, the electroactive subparticle used herein has various shapes, including, but not limited to, sphere, spheroid, fibril, fiber, or platelet. In certain embodiments, the electroactive subparticle used herein is substantially spherical. In certain embodiments, the electroactive subparticle used herein is spherical. In certain embodiments, the electroactive subparticle used herein is spheroidal.

In certain embodiments, the electroactive subparticles used herein have an average particle size ranging from about 10 nm to about 100 μm, from about 10 nm to about 10 μm, from about 20 nm to about 5 μm, from about 20 nm to about 1 μm, from about 1 nm to about 500 nm, from about 1 nm to about 200 nm, or from about 2 nm to 100 nm, from about 20 nm to about 500 nm, from about 50 to about 500 nm, from about 50 to about 400 nm, from about 50 to about 200 nm, or from about 100 to about 200 nm. In certain embodiments, the electroactive subparticles used herein have an average particle size ranging from about 50 nm to about 400 nm. In certain embodiments, the electroactive subparticles used herein have an average particle size ranging from about 50 nm to about 200 nm. In certain embodiments, the electroactive subparticles used herein have an average particle size ranging from about 100 nm to about 200 nm In certain embodiments, the electroactive subparticles used herein have an average particle size of about 50 nm, about 100 nm, about 150 nm, about 200 nm, about 300 nm, about 400 nm, about 500 nm, about 1 μ, about 2 μm, about 5 μm, or about 10 μm.

In certain embodiments, the electroactive subparticle used herein is coated to provide additional desired chemical and/or physical properties, such as chemical inertness (by coating with metal oxides, such as TiO₂, MoO₃, WO₃, Al₂O₃, or ZnO) or electrical conductivity (by coating with, e.g., ionic conductors or carbon). In certain embodiments, the electroactive subparticle used herein is coated with a metal oxide by mixing the electroactive subparticle with the metal oxide, e.g., in a grinder. In certain embodiments, the electroactive subparticle used herein is coated with a metal oxide by mixing the electroactive subparticle with a solution of polytitanic acid, polytungstic acid, polymolybdic acid, polytitanic acid peroxide, polytungstic acid peroxide, or polymolybdic acid peroxide, which forms the corresponding metal oxide upon dehydration.

In certain embodiments, the electroactive subparticle used herein is coated with a carbonized carbon layer. In certain embodiments, the electroactive subparticle used herein is first treated with a binder, including, but not limited to, asphalt pitch, pitch coke, petroleum coke, a sugar, coal tar, fluoranthene, pyrene, chrysene, phenanthrene, anthracene, naphthalin, fluorine, biphenyl, acenephthene, or a mixture thereof; and subsequently carbonized, in one embodiment, in an inert gas atmosphere, to form carbonized carbon layer on the surface of the electroactive subparticle.

In certain embodiments, the electroactive subparticle used herein is coated with carbon by thermal vapor deposition (CVD), as described in U.S. Pat. App. Pub. No. 2003/025711, the disclosure of which is incorporated herein by reference in its entirety.

b. Electroactive Subparticles for a Cathode

In one embodiment, the electroactive subparticle used herein comprises one or more electroactive materials, which are as defined herein. In another embodiment, the electroactive subparticle used herein comprises one electroactive material, which is as defined herein. In yet another embodiment, the electroactive subparticle used herein comprises two electroactive materials, which are as defined herein. In yet another embodiment, the electroactive subparticle used herein is an embedded subparticle that comprises two or more electroactive materials, which are as defined herein. In yet another embodiment, the electroactive subparticle used herein is an embedded subparticle that comprises two electroactive materials, wherein one of the electroactive material is embedded in the other electroactive material.

In certain embodiments, the electroactive subparticle used herein comprises a lithium compound. In one embodiment, the electroactive subparticle used herein comprises a lithium phosphate compound. In another embodiment, the electroactive subparticle used herein comprises LiMPO₄, wherein M is as defined herein. In yet another embodiment, the electroactive subparticle used herein comprises LiFePO₄. In yet another embodiment, the electroactive subparticle used herein comprises LiMnPO₄. In yet another embodiment, the electroactive subparticle used herein comprises LiVPO₄. In yet another embodiment, the electroactive subparticle used herein comprises AM^{a}_{1-d}M^{b}_{d}PO₄, wherein A, M^{a}, M^{b}, and are each as defined herein. In yet another embodiment, the electroactive subparticle used herein comprises _{LiM}^{a}_{1-d}M^{b}_{d}PO₄, wherein M^{a}, M^{b}, and d are each as defined herein. In still another embodiment, the electroactive subparticle used herein comprises NaM^{a}_{1-d}M^{b}_{d}PO₄, wherein M^{a}, M^{b}, and d are each as defined herein.

In certain embodiments, the electroactive subparticle used herein comprises (LiF)ₓFe₁₋ₓ, wherein 0<x<1.

In certain embodiments, the electroactive subparticle used herein comprises a metal oxide. In one embodiment, the electroactive subparticle used herein comprises selected from the group consisting of LiMn₂O₄, LiCoO₂, LiNiCoO₂, LiNiₑCo₁₋ₑPO₂, where c is from about 0.05 to about 0.95, from about 0.1 to about 0.90, from about 0.2 to about 0.5, or from about 0.2 to about 0.4,Li(NiMnCo)_{1/3}O₂, Li(NiMn)_{1/2}O₂, LiV₂O₅, LiAlNiCoO₂, LiNi_{1-a-b}AlaCo_{b}O₂ where a is from about 0.01 to about 0.5 and b is from about 0.01 to about 0.9, with the proviso that the sum of a and b is less than 1; and c is from about 0.01 to about 0.99, and mixtures thereof; wherein c is as defined herein. In one embodiment, the electroactive subparticle used herein comprises LiMn₂O₄ In another embodiment, the electroactive subparticle used herein comprises LiCoO₂ In yet another embodiment, the electroactive subparticle used herein comprises LiNiCoO₂. In yet another embodiment, the electroactive subparticle used herein comprises LiNiₑCo₁₋ₑO₂, wherein c is as defined herein. In yet another embodiment, the electroactive subparticle used herein comprises Li(NiMnCo)_{1/3}O₂. In yet another embodiment, the electroactive subparticle used herein comprises Li(NiMn)₁₁₂O₂. In yet another embodiment, the electroactive subparticle used herein comprises LiV₂O₅. In still another embodiment, the electroactive subparticle used herein comprises LiAlNiCoO₂.

In certain embodiments, the electroactive subparticle used herein comprises LiNiₑMn_{f}CO_{1-e-f}O₂, wherein e and f are each as defined herein. In one embodiment, the electroactive subparticle used herein comprises LiNiₑMn_{f}Co_{1-e-f}O₂, wherein e and f are each 0.33.

In certain embodiments, the electroactive subparticle used herein comprises LiNi_{1-a-b}AlₐCo_{b}O₂, wherein a and b are each as defined herein. In certain embodiments, the electroactive subparticle used herein comprises LiAl_{0.05}N_{0.8}Co_{0.15}O₂.

In certain embodiments, the electroactive subparticle used herein has various shapes, including, but not limited to, sphere, spheroid, fibril, fiber, or platelet. In certain embodiments, the electroactive subparticle used herein is substantially spherical. In certain embodiments, the electroactive subparticle used herein is spherical. In certain embodiments, the electroactive subparticle used herein is spheroidal.

In certain embodiments, the electroactive subparticles used herein have an average particle size ranging from about 10 nm to about 100 μm, from about 10 nm to about 10 μm, from about 20 nm to about 5 μm, from about 20 nm to about 1 μ, from about 1 nm to about 500 nm, from about 1 nm to about 200 nm, or from about 2 nm to 100 nm, from about 20 nm to about 500 nm, from about 50 to about 500 nm, from about 50 to about 400 nm, from about 50 to about 200 nm, or from about 100 to about 200 nm. In certain embodiments, the electroactive subparticles used herein have an average particle size ranging from about 50 nm to about 400 nm. In certain embodiments, the electroactive subparticles used herein have an average particle size ranging from about 50 nm to about 200 nm. In certain embodiments, the electroactive subparticles used herein have an average particle size ranging from about 100 nm to about 200 nm In certain embodiments, the electroactive subparticles used herein have an average particle size of about 50 nm, about 100 nm, about 150 nm, about 200 nm, about 300 nm, about 400 nm, about 500 nm, about 1 μ, about 2 μm, about 5 μm, or about 10 μm.

In certain embodiments, the electroactive subparticle used herein is coated to provide additional desired chemical and/or physical properties, such as chemical inertness (by coating with metal oxides, such as TiO₂, MoO₃, WO₃, Al₂O₃, or ZnO) or electrical conductivity (by coating with, e.g., ionic conductors or carbon). In certain embodiments, the electroactive subparticle used herein is coated with a metal oxide by mixing the electroactive subparticle with the metal oxide, e.g., in a grinder. In certain embodiments, the electroactive subparticle used herein is coated with a metal oxide by mixing the electroactive subparticle with a solution of polytitanic acid, polytungstic acid, polymolybdic acid, polytitanic acid peroxide, polytungstic acid peroxide, or polymolybdic acid peroxide, which forms the corresponding metal oxide upon dehydration.

In certain embodiments, the electroactive subparticle used herein is coated with a carbonized carbon layer. In certain embodiments, the electroactive subparticle used herein is first treated with a binder, including, but not limited to, asphalt pitch, pitch coke, petroleum coke, a sugar, coal tar, fluoranthene, pyrene, chrysene, phenanthrene, anthracene, naphthalin, fluorine, biphenyl, acenephthene, or a mixture thereof; and subsequently carbonized, in one embodiment, in an inert gas atmosphere, to form carbonized carbon layer on the surface of the electroactive subparticle.

In certain embodiments, the electroactive subparticle used herein is coated with carbon by thermal vapor deposition (CVD), as described in U.S. Pat. App. Pub. No. 2003/025711, the disclosure of which is incorporated herein by reference in its entirety.

Coated Non-Spherical Electroactive Particle

In one embodiment, provided herein is a coated non-spherical electroactive particle, comprising i) a non-spherical agglomerated particle provided herein and ii) a polymeric overcoating on the surface of the non-spherical agglomerated particle.

In one embodiment, the polymeric overcoating is an organic polymer. Suitable polymeric overcoatings include, but are not limited to, polyamideimides, polyimides, polytetrafluoroethylene (PTFE), carboxymethyl cellulose (CMC), polyvinylidene fluoride (PVDF), polyvinyl alcohol (PVA), styrene butadiene rubber (SBR), and mixtures thereof. In certain embodiments, the polymeric overcoating is a polyamideimide. In certain embodiments, the polymeric overcoating is a polyimide. In certain embodiments, the polymeric overcoating is a carboxymethyl cellulose.

In certain embodiments, the polymeric overcoating material is a crosslinkable polymer. Suitable crosslinkable polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinkable polymer is a polyamideimide. In certain embodiments, the crosslinkable polymer is a polyimide. In certain embodiments, the crosslinkable polymer is a carboxymethyl cellulose.

In certain embodiments, the polymeric overcoating material is a crosslinked polymer. Suitable crosslinked polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the crosslinked polymer is a polyamideimide. In certain embodiments, the crosslinked polymer is a polyimide. In certain embodiments, the crosslinked polymer is a carboxymethyl cellulose.

In certain embodiments, the polymeric overcoating is a thermally crosslinkable polymer. Suitable thermally crosslinkable polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the thermally crosslinkable polymer is a polyamideimide. In certain embodiments, the thermally crosslinkable polymer is a polyimide. In certain embodiments, the thermally crosslinkable polymer is a carboxymethyl cellulose.

In certain embodiments, the polymeric overcoating is a thermally crosslinked polymer. Suitable thermally crosslinked polymers include, but are not limited to, polybenzophenones, polyacrylates, polyvinyls, polystyrenes, polysulfones, 2,3-dihydrofuran-containing polymers, carboxymethyl celluloses (CMC), polyamideimides, polyimides, styrene-containing copolymers, and mixtures thereof. In certain embodiments, the thermally crosslinked polymer is a polyamideimide. In certain embodiments, the thermally crosslinked polymer is a polyimide. In certain embodiments, the thermally crosslinked polymer is a carboxymethyl cellulose.

In certain embodiments, the polymeric overcoating is a photo crosslinkable polymer. Suitable photo crosslinkable polymers include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the polymeric overcoating is a photo crosslinked polymer. Suitable photo crosslinked polymers include, but are not limited to, polybenzophenones, polyacrylates, polyvinyls, polystyrenes, polysulfones, 2,3-dihydrofuran-containing polymers, styrene-containing copolymers, and mixtures thereof.

In certain embodiments, the polymeric overcoating is formed from its precursors via polymerization on the surface of the core of the coated electroactive particle. In certain embodiments, the precursors of a polymer are monomers of the polymer. In certain embodiments, the precursors of a polymer are crosslinkable polymers. In certain embodiments, the polyamideimide as a polymeric overcoating is formed from a polyamideimide via crosslinking on the surface of the core of the coated electroactive particle. In certain embodiments, the polyimide as a polymeric overcoating is formed from a polyimide via crosslinking on the surface of the core of the coated electroactive particle.

In one embodiment, the polymeric overcoating is a polyamideimide, polyimide, or a mixture thereof. In certain embodiments, the polyamideimide is aromatic, aliphatic, cycloaliphatic, or a mixture thereof. In certain embodiments, the polyamideimide is an aromatic polyamideimide. In certain embodiments, the polyamideimide is an aliphatic polyamideimide. In certain embodiments, the polyamideimide is a cycloaliphatic polyamideimide. In certain embodiments, the polyimide is aromatic, aliphatic, cycloaliphatic, or a mixture thereof. In certain embodiments, the polyimide is an aromatic polyimide. In certain embodiments, the polyimide is an aliphatic polyimide. In certain embodiments, the polyimide is a cycloaliphatic polyimide.

In certain embodiments, the polymeric overcoating is TORLON® AI-30, TORLON® AI-50, TORLON® 4000, or TORLON® 4203L (Solvay Advanced Polymers, L.L.C., AbOyaretta, Ga.); or formed from U-VARNISH® (UBE American Inc., New York, N.Y.). In certain embodiments, the polymeric overcoating is TORLON® AI-30. In certain embodiments, the polymeric overcoating is TORLON® AI-50. In certain embodiments, the polymeric overcoating is TORLON® 4000. In certain embodiments, the polymeric overcoating is TORLON® 4203L. In certain embodiments, the polymeric overcoating is a polyimide formed from U-VARNISH® (UBE American Inc., New York, NY).

Some other suitable polyamideimide and polyimides include those described in Loncrini and Witzel, Journal of Polymer Science Part A-1: Polymer Chemistry 1969, 7, 2185-2193; Jeon and Tak, Journal of Applied Polymer Science 1996, 60, 1921-1926; Seino et al., Journal of Polymer Science Part A: Polymer Chemistry 1999, 37, 3584-3590; Seino et al., High Performance Polymers 1999, 11, 255-262; Matsumoto, High Performance Polymers 2001, 13, S85-S92; Schab-Balcerzak et al., European Polymer Journal 2002, 38, 423-430; Eichstadt et al., Journal of Polymer Science Part B: Polymer Physics 2002, 40, 1503-1512; and Fang et al., Polymer 2004, 45, 2539-2549; the disclosure of each of which is incorporated herein by reference in its entirety.

In certain embodiments, the polyamideimide as a polymeric overcoating is formed from a polyanhydride and a polyamine via polymerization on the surface of the core of the coated electroactive particle.

In certain embodiments, the polyimide as a polymeric overcoating is formed from a polyanhydride and a polyamine via polymerization on the surface of the core of the coated electroactive particle.

In certain embodiments, the aromatic, aliphatic, or cycloaliphatic polyamideimide overcoating is formed via a condensation reaction of an aromatic, aliphatic, or cycloaliphatic polyanhydride, in one embodiment, a dianhydride, with an aromatic, aliphatic, or cycloaliphatic polyamine, in one embodiment, a diamine or triamine

In certain embodiments, the aromatic, aliphatic, or cycloaliphatic polyimide overcoating is formed via a condensation reaction of an aromatic, aliphatic, or cycloaliphatic polyanhydride, in one embodiment, a dianhydride, with an aromatic, aliphatic, or cycloaliphatic polyamine, in one embodiment, a diamine or triamine, to form a polyamic acid; followed by chemical or thermal cyclization to form the polyimide.

Suitable polyanhydrides, polyamines, polyamideimide, and polyimides include those described in Eur. Pat. App. Pub. Nos. EP 0450549 and EP 1246280; U.S. Pat. No. 5,504,128; and U.S. Pat. App. Pub. Nos. 2006/0099506 and 2007/0269718, the disclosure of each of which is incorporated herein by reference in its entirety.

Suitable polyanhydrides include, but are not limited to, butanetetracarboxylic dianhydride, meso-1,2,3,4-butanetetracarboxylic dianhydride, dl-1,2,3,4-butanetetracarboxylic dianhydride, cyclobutane tetracarboxylic dianhydride, 1,2,3,4-cyclopentane tetracarboxylic dianhydride, cyclohexane tetracarboxylic dianhydride, 1,2,3,4-cyclohexanetetracarboxylic dianhydride, cis-1,2,3,4-cyclohexanetetracarboxylic dianhydride, trans-1,2,3,4-cyclohexanetetracarboxylic dianhydride, bicyclo[2.2.2]octane-2,3,5,6-tetracarboxylic 2,3:5,6-dianhydride, bicyclo[2.2.2]oct-7-ene-2,3,5,6-tetracarboxylic dianhydride, bicyclo[2.2.1]-heptane-2,3,5,6-tetracarboxylic 2,3:5,6-dianhydride, (4arH, 8acH)-decahydro-1,t,4t:5c,4-cyclohexene-1,1,2,2-tetracarboxylic 1,2:1,2-dianhydride, bicyclo[2.2.1]heptane-2-exo-3-exo-5-exo-tricarboxyl-5-endo-acetic dianhydride, bicyclo[4.2.0]oxetane-1,6,7,8-tetracarboxylic acid intramolecular dianhydride, 3,3′,4,4′-diphenylsulfonetetracarboxylic dianhydride, 4,4′-hexafluoropropylidene bisphthalic dianhydride, 1,3-bis(3,4-dicarboxyphenyl)-1,1,3,3-tetramethyldisiloxane, and combinations thereof.

Suitable polyamines include, but are not limited to, 4,4′-methylenebis(2,6-dimethylaniline), 4,4′-oxydianiline, m-phenylenediamine, p-phenylenediamine, benzidene, 3,5-diaminobenzoic acid, o-dianisidine, 4,4′-diaminodiphenyl methane, 4,4′-methylenebis(2,6-dimethylaniline), 1,4-diaminobutane, 1,6-diaminohexane, 1,7-diaminoheptane, 1,9-diaminononane, 1,10-diaminodecane, 1,12-diaminododecane, 5-amino-1,3,3-trimethylcyclohexanemethylamine, 2,5-bis(aminomethyl)bicyclo[2.2.1]heptane, 2,6-bis(aminomethyl)bicyclo[2.2.1]heptane, 2,4-diaminotoluene, 1,4-diamino-2-methoxybenzene, 1,4-diamino-2-phenylbenzene and 1,3-diamino-4-chlorobenzene, 4,4′-diaminobiphenyl, 2,2-bis(4-aminophenyl)propane, 2,2-bis[4-(4-aminophenoxy)phenyl]propane, 2,2-bis(4-aminophenyl)-1,1,1,3,3,3-hexafluoropropane, 2,2-bis(4-aminophenoxyphenyl)hexafluoropropane, 4,4′-diaminodiphenyl ether, 3,4-diaminodiphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis[4-(4-aminophenoxy)phenyl]propane, 2,2-bis[4-(4-aminophenoxy)phenyl]propane, 2,2-bis[4-(4-aminophenoxy)phenyl]-1,1,1,3,3,3-hexafluoropropane, 4,4′-diaminodiphenyl thioether, 4,4′-diaminodiphenyl sulfone, 2,2′-diaminobenzophenone, 3,3′-diaminobenzophenone, naphthalene diamines (including 1,8-diaminonaphthalene and 1,5-diaminonaphthalene), 2,6-diaminopyridine, 2,4-diaminopyrimidine, 2,4-diamino-s-triazine, 1,8-diamino-4-(aminomethyl)octane, bis[4-(4-aminophenoxy)-phenyl]sulfone, 3,3′-dihydroxy-4,4′-diaminobiphenyl, 2,2-bis(3-amino-4-hydroxyphenyl)hexafluoropropane, 2,2-bis(3-hydroxy-4-aminophenyl)propane, and combinations thereof.

In certain embodiments, the polyimide is poly(4,4′-phenyleneoxyphenylene pyromellitic imide) or poly(4,40′-phenyleneoxyphenylene-co-1,3-phenylene-benzophenonetetracarboxylic diimide).

In certain embodiments, a conductive polymer is also added to the polymeric overcoating to increase the conductivity of the coated electroactive particle. Suitable conductive polymers include, but are not limited to, polythiophene, poly(3-hexylthiophene), poly(2-acetylthiophene), polybenzothiopnene, poly(2,5-dimethylthiophene), poly(2-ethylthiophene), poly(3-carboxylic ethyl thiophene), polythiopheneacetonitrile, poly(3,4-ethylenedioxythiophene), polyisothianaphthene, polypyrrole, polyaniline, and polyparaphenylene. In certain embodiments, the conductive polymer is added to the overcoating polymer or precursors in an amount ranging from about 1 to about 40%, from about 2 to about 20%, from about 3 to about 15%, or from about 5 to about 10% of the total weight of the polymeric overcoating polymer and the conductive polymer. In certain embodiments, the conductive polymer is added to the overcoating polymer or precursors first before contacting with the non-spherical electroactive agglomerated particles or the subparticles.

In certain embodiments, the coated non-spherical electroactive particle provided herein has various shapes, including, but not limited to, ellipsoid, discoid, or toroid. In certain embodiments, the coated non-spherical electroactive agglomerated particle provided herein is ellipsoidal. In certain embodiments, the coated non-spherical electroactive agglomerated particle provided herein is discoidal. In certain embodiments, the coated non-spherical electroactive agglomerated particle provided herein is toroidal. In certain embodiments, the coated non-spherical electroactive agglomerated particle provided herein has at least one flattened surface. In certain embodiments, the coated non-spherical electroactive agglomerated particle provided herein has at least one concave surface.

In certain embodiments, the coated non-spherical electroactive particle has an average particle size ranging from about 100 nm to about 100 μm, from about 500 nm to about 50 μm, from about 1 to about 20 μm, from about 2 to about 15 μm, from about 3 to about 10 μm, or from about 3 to about 5 μm. In certain embodiments, the coated non-spherical electroactive particle has an average particle size of about 1 μ, about 2 μm, about 3 μm, about 4 μm, about 5 μm, about 6 μm, about 7 μm, about 8 μm, about 9 μm, or about 10 μm. In certain embodiments, the coated non-spherical electroactive particle has an average particle size of about 3 μm. In certain embodiments, the coated electroactive particle has an average particle size of about 4 μm. In certain embodiments, the coated non-spherical electroactive particle has an average particle size of about 5 μm.

In certain embodiments, the coated non-spherical electroactive particle has an average surface area ranging from about 0.1 to about 100 m²/g, from about 1 to about 50 m²/g, from about 2 to about 20 m²/g, from about 5 to about 20 m²/g, from about 2 to about 15 m²/g, from about 2 to about 10 m²/g, or from about 10 to about 15 m²/g.

In certain embodiments, the coated non-spherical electroactive particle is porous. In certain embodiments, the non-spherical coated electroactive particle has an average porosity as measured by density, ranging from about 0.1 to about 5 g/cm³, from about 0.2 to about 3 g/cm³, from about 0.5 to about 2 g/cm³, or from about 0.5 to about 1 g/cm³. In certain embodiments, the coated non-spherical electroactive particle has porosity of about 0.5, about 1, about 1.5, about 2, about 2.5, about 3, about 3.5, about 4, about, 4.5, or about 5 g/cm³.

In certain embodiments, the coated non-spherical electroactive particles have such particle size distribution that 10% of the coated non-spherical electroactive particles have a particle size of about 0.05 μm, about 0.1 μ, or about 1 μm; and 90% of the coated electroactive particles have a particle size of about 100 μm, about 50 μm, about 20 μm, about 10 μm, or about 5 μm. In certain embodiments the coated non-spherical electroactive particles have such particle size distribution that 10% of the coated non-spherical electroactive particles have a particle size of 1 μand 90% of the coated non-spherical electroactive particles have a particle size of 10 μm.

In certain embodiments, the coated non-spherical electroactive particle has a particle size ranging from about 100 nm to about 500 μm, from about 200 nm to about 200 μm, from about 500 nm to about 100 μm, from about 1 to about 50 μm, from about 10 to about 50 μm, from about 10 to about 40 μm, from about 10 to about 30 μm, or from about 10 to about 20 μm. In certain embodiments, the coated non-spherical electroactive particle has a particle size in the range from about 1 to about 50 μm.

In certain embodiments, the volume change of the coated non-spherical electroactive particle during a charging/discharging cycle is no more than about 400%, no more than about 350%, no more than about 300%, no more than about 250%, no more than about 200%, no more than about 150%, no more than 100%, no more than about 50%, no more than about 25%, or no more than about 10%.

In certain embodiments, the amount of volume change of the coated non-spherical electroactive particle during a charging/discharging cycle can be altered by addition of at least one diluent subparticle as described herein. In certain embodiments, the coated non-spherical electroactive particle provided herein comprises from about 5 to about 95%, from about 10 to about 90%, from about 20 to about 80%, from about 30 to about 75%, or from about 40 to about 60% of the electroactive subparticle by weight, and about 95 to about 5%, from about 90 to about 10%, from about 80 to about 20%, from about 70 to about 30%, or from about 60 to about 40% of the diluent subparticle by weight. In certain embodiments, the non-spherical agglomerated particle in the coated non-spherical electroactive particle provided herein comprises about 30%, about 35%, about 40%, about 45%, about 50%, about 55%, about 60%, about 65%, or about 70% of the electroactive subparticles by weight, and about 70%, about 65%, about 60%, about 55%, about 50%, about 45%, about 40%, about 35%, or about 30% of the diluent subparticles by weight. In certain embodiments, the agglomerated particle in the coated non-spherical electroactive particle provided herein comprises about 50% of the electroactive subparticles by weight, and about 50% of the diluent subparticles by weight.

Without being bound to any theory, one advantage of the coated non-spherical electroactive particle provided herein is that the electroactive particle can be used to make electrodes using conventional processing techniques, such as reverse roll coating or doctor blade coating. Without being bound to any theory, another advantage of the coated non-spherical electroactive particle provided herein is that, in manufacturing an electrode, the use of the coated non-spherical electroactive particles provided herein eliminates the high-temperature curing process typically associated with polyimides, which often leads to the oxidation of the current collector (e.g., a Cu foil) of the electrode

### Methods of Preparation

In one embodiment, provided herein is a method for preparing the non-spherical electroactive particle provided herein, which comprises the steps of: i) shear mixing one or more electroactive materials and optionally a binder in the presence of a solvent to form a mixture; and ii) spray drying the mixture to form the non-spherical electroactive particle. In one embodiment, the method further comprises the step of curing the non-spherical electroactive particle at an elevated temperature.

In another embodiment, provided herein is a method for preparing a non-spherical electroactive particle provided herein, which comprises the steps of: i) shear mixing the particles of one or more electroactive materials, and optionally a binder, in the presence of a solvent to form a mixture; and ii) spray drying the mixture to form the non-spherical electroactive particle. In one embodiment, the method further comprises the step of curing the non-spherical electroactive particle at an elevated temperature.

In certain embodiments, the methods provided herein further comprise the step of grinding the coated electroactive particles into predetermined particle sizes.

In certain embodiments, the elevated temperature is ranging from about 100 to about 1,000° C., from about 150 to about 750° C., from about 200 to about 700° C., from about 300 to about 600° C., or from about 300 to about 500° C. In certain embodiments, the elevated temperature is about 200° C., about 250° C., about 300° C., about 350° C., about 400° C., about 450° C., about 500° C., about 550° C., or about 600° C.

In certain embodiments, the solvent is N-methylpyrrolidinone (NMP). In certain embodiments, the solvent is water.

### Electrode

In one embodiment, provided herein is an electrode that comprises the non-spherical electroactive agglomerated particle provided herein or the coated non-spherical electroactive particles provided herein, a current collector, and optionally a binder.

The electrode provided herein can be used, for example, as either anodes or cathodes in batteries, depending on the electroactive subparticles used in forming the coated electroactive particles. In certain embodiments, the electrode provided herein is used as an anode. In certain embodiments, the electrode provided herein is used as an anode for a lithium ion battery. In certain embodiments, the electrode provided herein is used as a cathode. In certain embodiments, the electrode provided herein is used as a cathode for a lithium ion battery.

Examples of suitable materials for the current collector include, but are not limited to, carbon, copper, nickel, silver, and combinations thereof. Some suitable binders include those as described herein. In certain embodiments, the binder is selected from the group consisting of polyvinylidene fluoride (PVDF), carboxymethyl cellulose (CMC), styrene butadiene rubber (SBR), polyamideimides, polyimides, ethylene propylene diene monomer (EPDM), polyethylene oxides (PEO or PEG), polyethersulfones, polyphenylsulfones, and mixtures thereof.

In certain embodiments, the electrode is prepared by pressing the coated electroactive particles provided herein onto a current collector (e.g., a foil, strip, or sheet) to form an electrode. In certain embodiments, the electrode is prepared by dispersing the coated electroactive particles provided herein into a solvent, in one embodiment, N-methylpyrrolidinone (NMP), to form a slurry; and coating the slurry onto a current collect.

a. Anodes

In one embodiment, provided herein is an electrode that comprises i) a non-spherical electroactive agglomerated particle provided herein for an anode; ii) a current collector; and iii) optionally a binder.

In another embodiment, provided herein is an electrode that comprises i) a coated non-spherical electroactive particle provided herein for an anode; ii) a current collector; and iii) optionally a binder.

In certain embodiments, the current collector is copper. In certain embodiments, the current collector is copper foil. In certain embodiments, the current collector is rolled copper foil. In certain embodiments, the current collector is electrodeposited copper foil. In certain embodiments, the copper has a horizontal tensile strength ranging from about 100 to about 500 N/mm², from about 200 to about 450 N/mm², from about 250 to about 450 N/mm², or from about 300 to about 400 N/mm² In certain embodiments, the copper has a horizontal tensile strength of about 200, about 220, about 240, about 260, about 270, about 280, about 290, about 300, about 310, about 320, about 330, about 340, about 360, about 380, about 400, about 420, about 440, about 460, about 480, or about 500 N/mm². In certain embodiments, the copper has a vertical tensile strength ranging from about 100 to about 500 N/mm², from about 200 to about 450 N/mm², from about 250 to about 450 N/mm², or from about 300 to about 400 N/mm² In certain embodiments, the copper has a vertical horizontal strength of about 200, about 220, about 240, about 260, about 270, about 280, about 290, about 300, about 310, about 320, about 330, about 340, about 360, about 380, about 400, about 420, about 440, about 460, about 480, or about 500 N/mm²

Some suitable binders include those as described herein. In certain embodiments, the binder is selected from the group consisting of polyvinylidene fluoride (PVDF), carboxymethyl cellulose (CMC), styrene butadiene rubber (SBR), polyamideimides, polyimides, ethylene propylene diene monomer (EPDM), polyethylene oxides (PEO or PEG), polyethersulfones, polyphenylsulfones, and mixtures thereof.

b. Cathodes

In one embodiment, provided herein is an electrode that comprises i) a non-spherical electroactive agglomerated particle provided herein for a cathode; ii) a current collector; and iii) optionally a binder.

In another embodiment, provided herein is an electrode that comprises i) a coated non-spherical electroactive particle provided herein for a cathode; ii) a current collector; and iii) optionally a binder.

Examples of suitable materials for the current collector include, but are not limited to, aluminum, nickel, silver, and combinations thereof. Some suitable binders include those as described herein. In certain embodiments, the binder is selected from the group consisting of polyvinylidene fluoride (PVDF), carboxymethyl cellulose (CMC), styrene butadiene rubber (SBR), polyamideimides, polyimides, ethylene propylene diene monomer (EPDM), polyethylene oxides (PEO or PEG), polyethersulfones, polyphenylsulfones, and mixtures thereof.

In certain embodiments, the cathode is prepared by pressing the non-spherical electroactive agglomerated particles or coated electroactive particles provided herein onto a current collector (e.g., a foil, strip, or sheet) to form a cathode. In certain embodiments, the cathode is prepared by dispersing the non-spherical electroactive agglomerated particles or coated electroactive particles provided herein into a solvent, in one embodiment, N-methylpyrrolidinone (NMP), to form a slurry; and coating the slurry onto a current collect.

### Lithium Secondary Battery

In one embodiment, provided herein is a lithium secondary battery, which comprises an anode comprising the non-spherical electroactive agglomerated particles provided herein; a cathode; and electrolyte that separates the anode and cathode. The cathode can be any cathode for a lithium secondary battery known to one of ordinary skill in the art.

In another embodiment, provided herein is a lithium secondary battery, which comprises an anode comprising the coated non-spherical electroactive particles provided herein; a cathode; and electrolyte that separates the anode and cathode. The cathode can be any cathode for a lithium secondary battery known to one of ordinary skill in the art.

In yet another embodiment, provided herein is a lithium secondary battery, which comprises an anode; a cathode comprising the non-spherical electroactive agglomerated particles provided herein; and electrolyte that separates the anode and cathode. The anode can be any anode for a lithium secondary battery known to one of ordinary skill in the art.

In yet another embodiment, provided herein is a lithium secondary battery, which comprises an anode; a cathode comprising the coated non-spherical electroactive particles provided herein; and electrolyte that separates the anode and cathode. The anode can be any anode for a lithium secondary battery known to one of ordinary skill in the art.

In yet another embodiment, provided herein is a lithium secondary battery, which comprises an anode comprising the non-spherical electroactive agglomerated particles provided herein; a cathode comprising the non-spherical electroactive agglomerated particles provided herein; and electrolyte that separates the anode and cathode.

In still another embodiment, provided herein is a lithium secondary battery, which comprises an anode comprising the coated non-spherical electroactive particles provided herein; a cathode comprising the coated non-spherical electroactive particles provided herein; and electrolyte that separates the anode and cathode.

Any electrolytes known to one of ordinary skill in the art can be used in the battery provided herein. In certain embodiments, the electrolyte comprises one or more lithium salts and a charge carrying medium in the form of a solid, liquid, or gel. Suitable lithium salts include, but are not limited to LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof.

Suitable examples of solid charge carrying media include, but are not limited to, polymeric media, e.g., polyethylene oxide. Suitable examples of liquid charge carrying media include , but are not limited to, ethylene carbonate, propylene carbonate, dimethyl carbonate, diethyl carbonate, ethyl-methyl carbonate, butylene carbonate, vinylene carbonate, fluorinated ethylene carbonate, fluorinated propylene carbonate, γ-butylrolactone, methyl difluoroacetate, ethyl difluoroacetate, dimethoxyethane, diglyme (i.e., bis(2-methoxyethyl)ether), tetrahydrofuran, dioxolane, and combinations thereof. Some examples of charge carrying media gels include those described in U.S. Pat. Nos. 6,387,570 and 6,780,544, the disclosure of each of which is incorporated herein by reference in its entirety.

The disclosure will be further understood by the following non-limiting examples.

### EXAMPLES

### Example 1

### Electrode and Cell Fabrication

Negative and positive electrodes were coated onto an Al foil and Cu foil, respectively, using a small doctor blade coater, and then calendared to designed thickness. The electrodes were then slited to designed width and dried in a vacuum oven at an elevated temperature. Once the electrodes were dried, all subsequent cell fabrication steps were carried out inside a drying room at a Dew point of about −35° C. The electrodes were tabbed first and then wound into jellyrolls. The jellyrolls were then inserted into an 18650 can and an EC based electrolyte was put into the cell under vacuum. The cells were crimped for sealing after electrolyte filling. The cell was then be aged and formed.

### Example 2

### Cell Testing

A cell was tested one week after formation. The cell capacities and voltage profiles at ˜1 C and ˜5 C (or ˜10 C for Mn mixed particles) were measured by the following procedure: i) the cell was charged to 3.9V at 0.6A for 2.5 hours; ii) the cell then rested for several minutes; iii) the cell was discharged to 2.2 V at 1 C rate; iv) the cell rested for another several minutes; v) the cell was then charged to 3.9V at 0.6A; vi) the cell rested for several minutes; and vii) the cell was discharged to 2.2 V at ˜5 C or ˜10 C depending on the mixed particles.

### Example 3

### Preparation of Non-Spherical Electroactive Agglomerated Particles

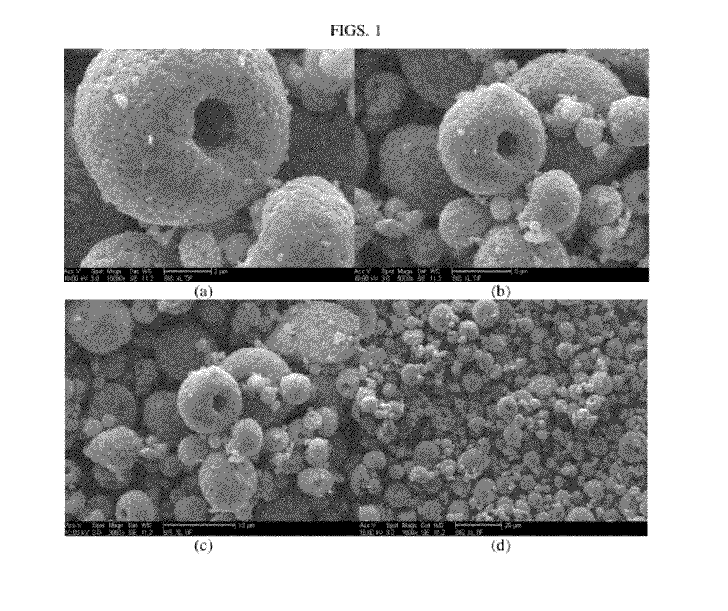

Non-spherical electroactive agglomerated particles comprising about 69% by weight of LiFePO₄, about 30% by weight of LiNiCoAlO₂, and about 1% by weight of TORLON® AI-50 as a binder were prepared by first shear mixing raw LiFePO₄ (Phostech Lithium, Inc., St-Bruno de Montarville, Canada) and LiNiCoAlO₂ (Toda Kogyo Corp., Hiroshima, Japan) in the presence of TORLON® AI-50 with a Silverson L5-M-A mixer (Silverson Machines, Chesham Bucks, England) in water at 5,000 rpm for one hour. The resulting mixture, which contained about 50% by weight of solids (LiFePO₄ and LiNiCoAlO₂) in water, was spray dried to form non-spherical electroactive agglomerated particles. The resulting non-spherical electroactive agglomerated particles were characterized by Scanning Electron Microscopy (SEM). Their SEM images are shown in FIGS. 1A, 1B, 1C, and 1D.

### Example 4

### Preparation of Non-Spherical Electroactive Agglomerated Particles

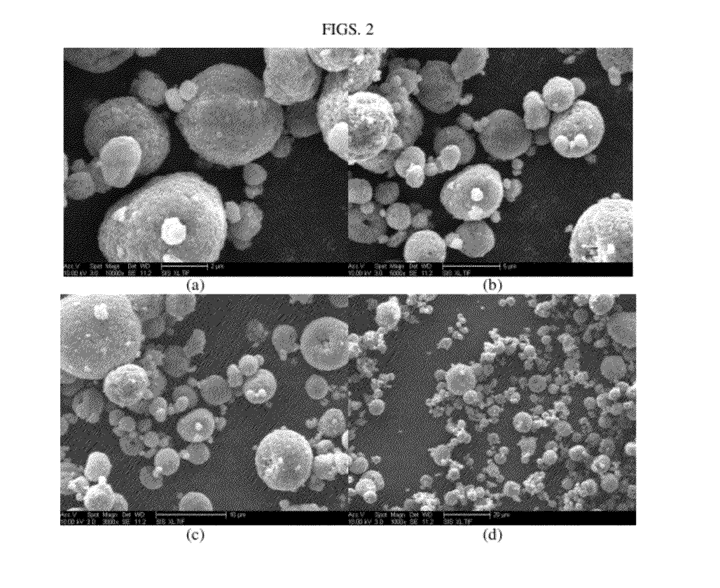

Non-spherical electroactive agglomerated particles comprising about 67% by weight of LiFePO₄, about 28% by weight of LiNiCoAlO₂, about 0.9% by weight of TORLON® AI-50 as a binder, and about 5% by weight of sucrose were prepared by first cryomilling raw LiFePO₄ (Phostech Lithium, Inc., St-Bruno de Montarville, Canada) and LiNiCoAlO₂ (Toda Kogyo Corp., Hiroshima, Japan) into nanoparticles of a size from about 100 to 200 nm The mixture of LiFePO₄ and LiNiCoAlO₂ was spray dried with TORLON® AI-50 and sucrose to form non-spherical electroactive agglomerated particles. The resulting non-spherical electroactive agglomerated particles were characterized by Scanning Electron Microscopy (SEM). Their SEM images are shown in FIGS. 2A, 2B, 2C, and 2D.

### Example 5

### Preparation of Non-Spherical Electroactive Agglomerated Particles

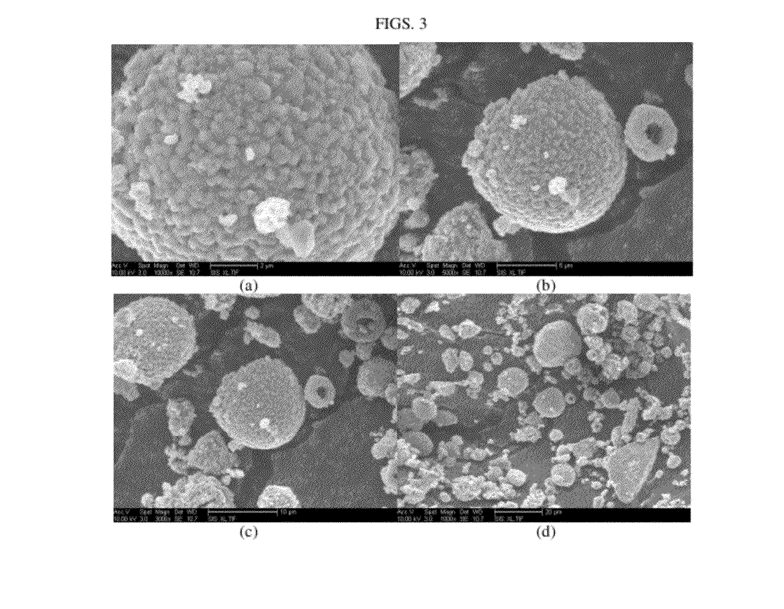

A mixture containing about 70% by weight of LiMn₂O₄ and about 30% by weight of LiNiCoAlO₂ powders was cryomilled to form nanoparticles of a size from about 100 to 200 nm. Non-spherical electroactive agglomerated particles comprising about 70% by weight of LiMn₂O₄, about 30% by weight of LiNiCoAlO₂, and about 0.5% by weight of TORLON® AI-50 as a binder were prepared by first shear mixing LiMn₂O₄ (Lico Technology Corp., Tao-Yuan Hsien, Taiwan) and LiNiCoAlO₂ (Toda Kogyo Corp., Hiroshima, Japan) in the presence of TORLON® AI-50 with a Silverson L5-M-A mixer (Silverson Machines, Chesham Bucks, England) in water at 5,000 rpm for 30 min The resulting mixture, which contained about 50% by weight of solids (LiMn₂O₄ and LiNiCoAlO₂) and about 0.5% by weight of the binder (TORLON® AI-50), was spray dried to form non-spherical electroactive agglomerated particles. The non-spherical electroactive agglomerated particles were cured at 300° C. for 10 min The resulting non-spherical electroactive agglomerated particles were characterized by Scanning Electron Microscopy (SEM). Their SEM images are shown in FIGS. 3A, 3B, 3C, and 3D.

### Example 6

### Preparation of Non-Spherical Electroactive Agglomerated Particles

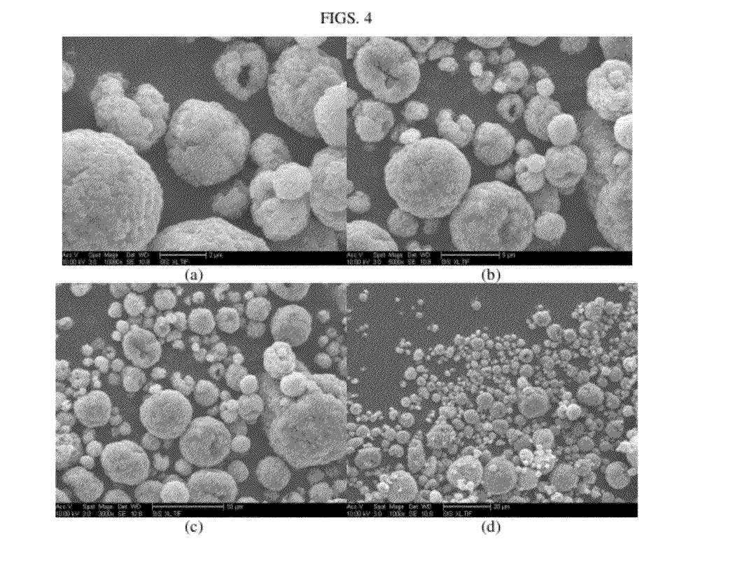

Silicon (Si) powders were cryomilled to form subparticles of a size from about 100 to 200 nm. Non-spherical electroactive agglomerated particles comprising Si and binder AI-50 were prepared by first shear mixing Si in the presence of TORLON® AI-50 with a Silverson LS-M-A mixer (Silverson Machines, Chesham Bucks, England) in water at 5,000 rpm for 30 min The mixture, which contained about 29% by weight of solid (Si) and about 8.4% by weight of the binder (TORLON® AI-50), was spray dried to form non-spherical electroactive agglomerated particles, which were cured at 300° C. for 10 min The non-spherical electroactive agglomerated particles were characterized by Scanning Electron Microscopy (SEM). Their SEM images are shown in FIGS. 4A, 4B, 4C, and 4D.

### Example 7

### Preparation of Coated Non-Spherical Electroactive Particles

The non-spherical agglomerated particles from one of Examples 3 to 6 are sprayed with a solution of a polyamideimide (e.g., TORLON® AI-30, TORLON® AI-50, TORLON® 4000, or TORLON® 4203L) in a solvent (e.g., N-methylpyrrolidinone). The agglomerated particles are further cured at an elevated temperature (e.g., about 300° C.) to form coated non-spherical electroactive particles.

### Example 8

### Preparation of Coated Non-Spherical Electroactive Particles

The non-spherical agglomerated particles from one of Examples 3 to 6 are sprayed with a solution of precursors of a polyimide (e.g., U-VARNISH®) in a solvent (e.g., N-methylpyrrolidinone). The wet agglomerated particles are further cured at an elevated temperature (e.g., about 300° C.) to form coated non-spherical electroactive particles.

### Example 9

### Preparation of Coated Non-Spherical Electroactive Particles

The non-spherical agglomerated particles from one of Examples 3 to 6 are added to a solution of a polyamideimide (e.g., TORLON® AI-30, TORLON® AI-50, TORLON® 4000, or TORLON® 4203L) in a solvent (e.g., N-methylpyrrolidinone) to form a uniform suspension, which is hot spray dried to form coated non-spherical electroactive particles. The coated non-spherical electroactive particles are further cured at an elevated temperature (e.g., about 300° C.).

### Example 10

### Preparation of Coated Non-Spherical Electroactive Particles

The non-spherical agglomerated particles from one of Examples 3 to 6 are added to a solution of precursors of a polyimide (e.g., U-VARNISH®) in a solvent (e.g., N-methylpyrrolidinone) to form a uniform suspension, which is hot spray dried to form coated non-spherical electroactive particles. The coated non-spherical electroactive particles are further cured at an elevated temperature (e.g., about 300° C.).

### Example 11

### Preparation of Non-Spherical Electroactive Agglomerated Particles

Commercial silicon was grinded by cryomilling to nanoparticles (about 100 to 2000 nm). The resulting Si nanoparticles (69.6 g, 91.5% by weight) were mixed with polyimide AI-50 (6.4 g, 8.5% by weight). The mixture was spray dried to form non-spherical electroactive agglomerated particles under the following conditions: air pressure from tank, 115 psi; atomizing air, 2 MPa; in temperature, 150° C.; out temperature, 79° C.; pump, 2; blower, 7; liquid flow rate, 2; and solid content, 29%.

The examples set forth above are provided to give those of ordinary skill in the art with a complete disclosure and description of how to make and use the claimed embodiments, and are not intended to limit the scope of what is disclosed herein. Modifications that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

What is claimed is:

1. A non-spherical electroactive agglomerated particle, comprising one or more electroactive materials and optionally a binder, wherein the non-spherical electroactive agglomerated particle is ellipsoidal, discoidal, or toroidal.

2. The non-spherical electroactive agglomerated particle of claim 1, wherein the non-spherical electroactive agglomerated particle has an average particle size from about 100 nm to about 10 μm.

3. The non-spherical electroactive agglomerated particle of claim 1, comprising one electroactive material and a binder.

4. The non-spherical electroactive agglomerated particle of claim 3, comprising subparticles of one electroactive material.

5. The non-spherical electroactive agglomerated particle of claim 4, comprising a single type of subparticles of one electroactive material.

6. The non-spherical electroactive agglomerated particle of claim 3, wherein the subparticles have an average size ranging from about 100 nm to about 10 μm.

7. The non-spherical electroactive agglomerated particle of claim 3, wherein the electroactive material is an electroactive material for an anode.

8. The non-spherical electroactive agglomerated particle of claim 7, wherein the electroactive material is an electroactive metal or metal oxide.

9. The non-spherical electroactive agglomerated particle of claim 8, wherein the electroactive material is Si, SiO, Li₄Ti₅O₁₂, SnO, WO₂, Si₇₀Fe₁₀Ti₁₀C₁₀, TiS₂, MoS₂, or a mixture thereof.

10. The non-spherical electroactive agglomerated particle of claim 9, wherein the volume change of the non-spherical electroactive agglomerated particle during a charging/discharging cycle is no more than about 200%.

11. The non-spherical electroactive agglomerated particle of claim 1, comprising a first and second electroactive material, and a binder.

12. The non-spherical electroactive agglomerated particle of claim 11, comprising subparticles of a first electroactive material and subparticles of a second electroactive material.

13. The non-spherical electroactive agglomerated particle of claim 12, wherein the subparticles of the first electroactive material have an average size ranging from about 100 nm to about 10 μm.

14. The non-spherical electroactive agglomerated particle of claim 12, wherein the subparticles of the second electroactive material have an average size ranging from about 100 nm to about 10 μm.

15. The non-spherical electroactive agglomerated particle of claim 11, wherein the first and second electroactive materials are electroactive materials for a cathode.

16. The non-spherical electroactive agglomerated particle of claim 11, wherein the first electroactive material is LiMPO₄ or (LiF)ₓFe₁₋ₓ, wherein M is a transition metal selected from the group consisting of Ti, V, Cr, Mn, Fe, Co, and Ni; and wherein 0<x<1.

17. The non-spherical electroactive agglomerated particle of claim 16, wherein the first electroactive material is selected from the group consisting of LiFePO₄, LiMnPO₄, LiVPO₄, and mixtures thereof.

18. The non-spherical electroactive agglomerated particle of claim 11, wherein the first electroactive material is AM^{a}_{1-d}M^{b}_{d}PO₄, wherein A is Li, Na, or a mixture thereof; M^{a} is Fe, Co, Mn, or a mixture thereof; M^{b} is Mg, Ca, Zn, Ni, Co, Cu, Al, B, Cr, Nb, or a mixture thereof; and d is from about 0.01 to about 0.30.

19. The non-spherical electroactive agglomerated particle of claim 11, wherein the first electroactive material is a metal oxide.

20. The non-spherical electroactive agglomerated particle of claim 19, wherein the first electroactive material is LiMn₂O₄.

21. The non-spherical electroactive agglomerated particle of claim 11, wherein the second electroactive material is an electroactive metal or metal oxide.

22. The non-spherical electroactive agglomerated particle of claim 21, wherein the electroactive metal or metal oxide is selected from the group consisting of LiCoO₂, LiNiCoO₂, Li(NiMnCo)_{1/3}O₂, Li(NiMn)_{1/2}O₂, LiNi_{c}Co_{1-c}O₂, LiV₂O₅, LiAlNiCoO₂, LiNi_{1-a-b}AlₐCo_{b}O₂, and mixtures thereof; where a is from about 0.01 to about 0.5 and b is from about 0.01 to about 0.9, with the proviso that the sum of a and b is less than 1; and c is from about 0.01 to about 0.99.

23. The non-spherical electroactive agglomerated particle of claim 21, wherein the electroactive metal or metal oxide is selected from the group consisting of LiCoO₂, LiAl_{0.05}Ni_{0.8}Co_{0.15}O₂, LiNiCoO₂, Li(NiMnCo)_{1/3}O₂, Li(NiMn)_{1/2}O₂, Co₁₋ₓO₂, LiAlNiCoO₂, and LiV₂O₅, where x is greater than 0 but smaller than about 10.

24. The non-spherical electroactive agglomerated particle of claim 11, comprising from about 30 to about 95% by weight of the first electroactive material and from about 70 to about 5% by weight of the second electroactive material.

25. The non-spherical electroactive agglomerated particle of claim 1, wherein the binder is an oxide.

26. The non-spherical electroactive agglomerated particle of claim 25, wherein the binder is Al₂O₃, P₂O₅, or LiPO₃, or a mixture thereof.

27. The non-spherical electroactive agglomerated particle of claim 1, wherein the binder is a polymer.

28. The non-spherical electroactive agglomerated particle of claim 27, wherein the binder is a crosslinkable polymer.

29. The non-spherical electroactive agglomerated particle of claim 27, wherein the binder is a polyamideimide or polyimide.

30. The non-spherical electroactive agglomerated particle of claim 27, wherein the binder is TORLON AI-30, TORLON AI-50, TORLON 4000, or TORLON 4203L.

31. The non-spherical electroactive agglomerated particle of claim 4, wherein the binder is formed from precursors of the polymer on the surface of the electroactive subparticles.

32. The non-spherical electroactive agglomerated particle of claim 31, wherein the precursors are U-VARNISH.

33. A coated non-spherical electroactive particle, comprising i) the non-spherical agglomerated particle of claim 1, and ii) a polymeric overcoating on the surface of the non-spherical agglomerated particle.

34. An electrode comprising the non-spherical electroactive agglomerated particle of claim 1, a current collector, and optionally a binder.
